(19) United States
(12) Patent Application Publication
(10) Pub. No.: US 2026/0270343 A1
(43) Pub. Date: Sep. 10, 2026

(54) SYSTEMS AND METHODS FOR SPAM CALL REPORTING

(71) Applicant: Boost SubscriberCo L.L.C., Englewood, CO (US)

(72) Inventors: Nay Soe, Highlands Ranch, CO (US); Rohit Singh, Littleton, CO (US)

(21) Appl. No.: 19/071,346

(22) Filed: Mar. 5, 2025

(51) Int. Cl. H04M 3/436; H04L 65/1016; H04L 65/1104

(52) U.S. Cl. CPC H04M 3/436; H04L 65/1016; H04L 65/1104

(57) ABSTRACT

A disclosed method may include (i) receiving, at a User Equipment (UE), a telephone call from a calling party number, (ii) displaying, in response to the UE detecting that the calling party number is a spam candidate, an option within a native dialer application of the UE that reports the calling party number as spam, and (iii) transmitting, in response to receiving user input selecting the option within the native dialer application of the UE that reports the calling party number as spam, a Session Initiation Protocol (SIP) update message from the native dialer application to an IP Multimedia Subsystem (IMS) that includes information identifying the calling party number as spam such that the IMS updates a spam database with the information identifying the calling party number.

### BRIEF SUMMARY

This disclosure is generally directed to systems, methods, and computer-readable media relating to spam call reporting. Telecommunications networks have become an integral part of modern society, facilitating communication across vast distances and enabling the exchange of information on a global scale. As these networks have evolved, so too have the challenges associated with their use. One such challenge that has emerged in recent years is the proliferation of spam calls, which may inundate users with unwanted and potentially harmful communications. These spam calls may range from mere nuisances to sophisticated attempts at fraud or identity theft, posing significant risks to both individual users and the integrity of the telecommunications infrastructure as a whole. In response to this growing concern, various techniques have been developed to identify and mitigate the impact of spam calls. However, many existing solutions may fall short in providing comprehensive and real-time protection against this ever-evolving threat. A significant issue with current spam call prevention techniques is their reliance on static databases or predefined rules to identify potential threats. These methods may struggle to keep pace with the rapidly changing tactics employed by spam callers. Spammers may frequently change their phone numbers, use spoofing techniques to mask their true identities, or employ sophisticated social engineering tactics to bypass filtering mechanisms. As a result, users may still find themselves inundated with unwanted calls, despite the presence of ostensibly protective measures. This limitation underscores the need for desire dynamic and adaptive solutions that may evolve in real-time to address new and emerging threats in the telecommunications landscape.

One potential solution to the challenges posed by spam calls may involve the development of a real-time, community-driven reporting system integrated directly into native dialer applications. This technique may leverage the collective experiences and insights of a vast user base to create a dynamic and constantly updated database of known spam numbers. By allowing users to quickly and easily report suspected spam calls as they occur, this system may overcome the limitations of static databases and predefined rules. The integration of such a reporting mechanism into the native dialer application may eliminate the need for separate third-party applications, streamlining the user experience and reducing potential security risks associated with granting additional permissions to external software. This integrated technique may involve modifications to the user interface of the dialer application, potentially including a prominent "Report as Spam" button that users may access during or immediately after a call. When a user flags a number as spam, the system may generate a Session Initiation Protocol (SIP) update message containing information about the reported number. This SIP update may then be transmitted through the IP Multimedia Subsystem (IMS) to a centralized spam database. The use of existing telecommunications protocols and infrastructure for this reporting mechanism may ensure seamless integration with current systems while providing a foundation for rapid and widespread adoption.

Another significant challenge in the fight against spam calls is the lack of standardized protocols for sharing information about known spam numbers or techniques across different networks and jurisdictions. This fragmentation may hinder the development of comprehensive, wide-reaching solutions and may allow spam callers to exploit differences in regulations and enforcement capabilities between regions. The global nature of telecommunications networks means that effective spam prevention may require coordination and information sharing on an international scale. However, achieving this level of cooperation may be complicated by varying privacy laws, regulatory frameworks, and technological capabilities across different countries and service providers. Additionally, the sheer volume of data that would need to be shared and processed in real-time to effectively combat spam calls on a global scale presents significant technical challenges. These challenges may include issues of data storage, transmission speeds, and the ability to quickly analyze and act upon incoming information about potential spam activity.

To address the challenges of cross-border and cross-network spam prevention, a potential solution may involve the implementation of a centralized system for sharing spam call data. This technique may provide a secure, transparent, and globally accessible method for telecommunications providers, regulatory bodies, and end-users to contribute and access information about known spam numbers and techniques. The system may operate alongside existing telecommunications infrastructure, potentially interfacing with the IP Multimedia Subsystem (IMS) and other network components to facilitate the rapid dissemination of spam-related information. In practice, this system may work by creating a centralized database of reported spam numbers and associated metadata, such as the time and frequency of reported calls, geographical information, and any patterns or characteristics identified in the spam activity. When a user reports a number as spam through their native dialer application, this information may be transmitted via a SIP update message to the IMS, which may then forward the information to the centralized spam database. Telecommunications providers and other authorized entities may then access this information in real-time, using it to update their spam filters and blocking mechanisms. This centralized technique may ensure that all participating networks have access to the most up-to-date information on spam activities, potentially improving the overall effectiveness of spam prevention efforts across multiple jurisdictions.

The user interface and experience of spam call prevention features play a significant role in their effectiveness and adoption. Many existing solutions may have complex or unintuitive interfaces that discourage users from actively participating in spam prevention efforts. This lack of user engagement may result in missed opportunities to identify and report new spam numbers, ultimately reducing the overall effectiveness of the spam prevention system. Additionally, the fragmented nature of many existing prevention techniques may exacerbate this issue. Users may be required to download and maintain separate applications or services to supplement the basic call filtering capabilities provided by their devices or carriers. This fragmentation may lead to a suboptimal user experience, as individuals may need to navigate multiple interfaces or settings to manage their call preferences effectively. Moreover, the reliance on third-party applications may introduce additional security and privacy concerns, as users may be required to grant these applications access to sensitive information or call logs.

Improving the user interface and experience of spam call prevention features may contribute significantly to their effectiveness and adoption. By integrating robust reporting and management tools directly into native dialer applications, users may be empowered to take a more active role in protecting themselves and others from unwanted calls. These interfaces may be designed to be intuitive and user-friendly, allowing individuals to quickly report suspected spam calls with minimal effort. For example, a simple "Report Spam" button may be prominently displayed during or immediately after a call, enabling users to flag suspicious numbers with a single tap. A more integrated and seamless solution that leverages the native capabilities of devices and telecommunications networks may provide a more efficient and user-friendly technique for spam call prevention. Such an integrated technique may involve incorporating advanced spam detection and reporting features directly into the native dialer applications of mobile devices. This integration may allow users to report suspected spam calls with a single tap, contributing to a shared database of known spam numbers without the need for additional software. Furthermore, by utilizing the existing infrastructure of telecommunications networks, this technique may provide more comprehensive coverage and faster response times to emerging threats.

In some examples, a method includes (i) receiving, at a User Equipment (UE), a telephone call from a calling party number, (ii) displaying, in response to the UE detecting that the calling party number is a spam candidate, an option within a native dialer application of the UE that reports the calling party number as spam, and (iii) transmitting, in response to receiving user input selecting the option within the native dialer application of the UE that reports the calling party number as spam, a Session Initiation Protocol (SIP) update message from the native dialer application to an IP Multimedia Subsystem (IMS) that includes information identifying the calling party number as spam such that the IMS updates a spam database with the information identifying the calling party number.

In some example, the method further comprises receiving, at the UE, a subsequent telephone call from the calling party number and displaying, based on the updated spam database, an indication that the calling party number is associated with spam.

In some examples, detecting that the calling party number is a spam candidate comprises comparing the calling party number to a local spam database stored on the UE.

In some examples, the SIP update message comprises a payload that includes the calling party number or a unique identifier associated with the calling party.

In some examples, wherein the IMS comprises a Proxy-Call Session Control Function (P-CSCF), a Serving-Call Session Control Function (S-CSCF), or an Interrogating-Call Session Control Function (I-CSCF).

In some examples, the method further comprises receiving, at the UE, a SIP INVITE message for an incoming call and extracting spam status information from a header of the SIP INVITE message.

In some examples, the spam database comprises a local database associated with a service provider or a national database associated with a regulatory agency.

In some examples, the method further comprises displaying, within the native dialer application of the UE, a user interface element that enables selection of a reason for reporting the calling party number as spam and including the selected reason in the SIP update message transmitted to the IMS.

In some examples, the method further comprises receiving, at the UE, a notification from the IMS indicating that the calling party number has been confirmed as spam based on reports from multiple UEs and updating a local spam list stored on the UE to include the confirmed spam number.

In some examples, the native dialer application comprises a user interface element for reporting spam that is integrated into a call screen or a call log.

In some examples, the method further comprises including authentication information in the SIP update message to enable verification using a Secure Telephone Identity Revisited (STIR) protocol or a Signature-based Handling of Asserted information using toKENs (SHAKEN) framework.

In some examples, the method further comprises receiving, at the UE, a confirmation from the IMS that the spam database has been updated based on the SIP update message.

In some examples, the method further comprises receiving, at the UE, a list of known spam numbers from the IMS and storing the list in a local cache on the UE.

In some examples, the option to report the calling party number as spam is displayed within the native dialer application during the telephone call.

In some examples, the method further comprises receiving, at the UE, a user input to unmark a previously reported spam number and transmitting a second SIP update message to the IMS that includes information requesting removal of the calling party number from the spam database.

In some examples, detecting that the calling party number is a spam candidate comprises analyzing call frequency, call duration, or time of day of previous calls from the calling party number.

In some examples, a non-transitory computer-readable medium has instructions stored thereon that, when executed by at least one physical computing processor, cause a computing device to perform operations comprising (i) receiving, at a User Equipment (UE), a telephone call from a calling party number, (ii) displaying, in response to the UE detecting that the calling party number is a spam candidate, an option within a native dialer application of the UE that reports the calling party number as spam, and (iii) transmitting, in response to receiving user input selecting the option within the native dialer application of the UE that reports the calling party number as spam, a Session Initiation Protocol (SIP) update message from the native dialer application to an IP Multimedia Subsystem (IMS) that includes information identifying the calling party number as spam such that the IMS updates a spam database with the information identifying the calling party number.

In some examples, a system comprises at least one physical computing processor of a computing device and a non-transitory computer-readable medium that has instructions stored thereon that, when executed by the at least one physical computing processor, cause the computing device to perform operations comprising (i) receiving, at a User Equipment (UE), a telephone call from a calling party number, (ii) displaying, in response to the UE detecting that the calling party number is a spam candidate, an option within a native dialer application of the UE that reports the calling party number as spam, and (iii) transmitting, in response to receiving user input selecting the option within the native dialer application of the UE that reports the calling party number as spam, a Session Initiation Protocol (SIP) update message from the native dialer application to an IP Multimedia Subsystem (IMS) that includes information identifying the calling party number as spam such that the IMS updates a spam database with the information identifying the calling party number.

### BRIEF DESCRIPTION OF THE DRAWINGS

For a better understanding of the present invention, reference will be made to the following Detailed Description, which is to be read in association with the accompanying drawings:

FIG. 1 shows an example flow diagram for a method relating to spam call reporting.

FIG. 2 illustrates an example graphical user interface and message flow for reporting spam messages.

FIG. 3 shows an example user interface for network call protection and a system diagram for spam call reporting.

FIG. 4 illustrates examples of a sequence diagram for spam call reporting and a system architecture for handling spam calls.

FIG. 5 shows an example user interface for reporting spam calls on a mobile device.

FIG. 6 illustrates an example system architecture for spam call reporting and data sharing.

FIG. 7 shows an example sequence diagram for a spam call reporting process.

FIG. 8 illustrates various example user interface screens for spam call reporting and management.

FIG. 9 shows an example side-by-side comparison of spam call targeting and prevention scenarios.

FIG. 10 illustrates an example series of user interfaces depicting the real-world process of spam call reporting and prevention.

FIG. 11 shows a diagram of an example computing system that may facilitate the performance of one or more of the methods described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

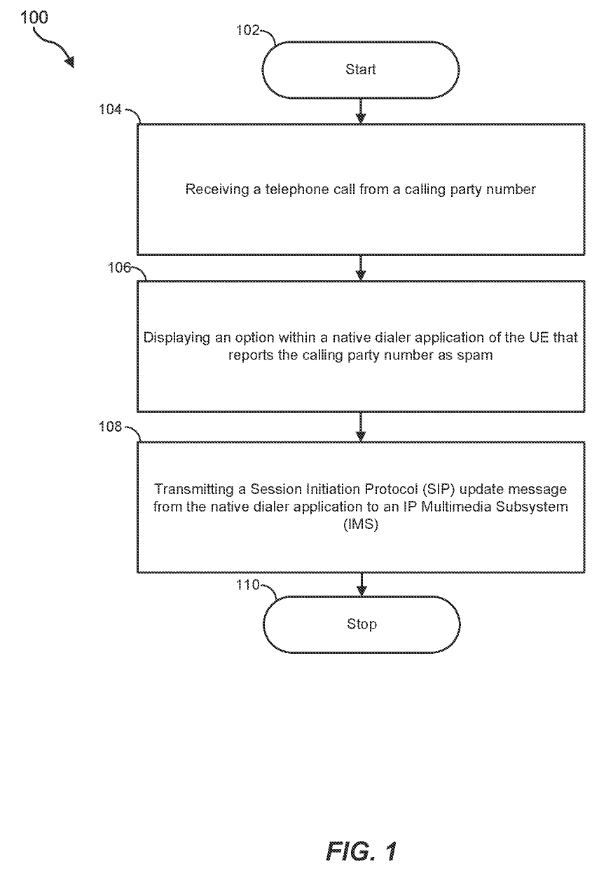

FIG. 1 shows a flow diagram for a method 100 relating to spam call reporting. At step 102, method 100 may start. At step 104, method 100 includes receiving, at a User Equipment (UE), a telephone call from a calling party number. At step 106, method 100 includes displaying, in response to the UE detecting that the calling party number is a spam candidate, an option within a native dialer application of the UE that reports the calling party number as spam. At step 108, method 100 includes transmitting, in response to receiving user input selecting the option within the native dialer application of the UE that reports the calling party number as spam, a Session Initiation Protocol (SIP) update message from the native dialer application to an IP Multimedia Subsystem (IMS) that includes information identifying the calling party number as spam such that the IMS updates a spam database with the information identifying the calling party number. At step 110, method 100 ends. The term “spam candidate” may generally indicate that the system has flagged the call as potential spam without necessarily having absolute certainty that it is spam, as understood by those having skill in the art. The term “native dialer” may generally refer to the default or primary dialing application established by an original equipment manufacturer on a phone, which may be integrated with the phone’s operating system or may have higher privileges or priority than other third-party dialing applications, for example.

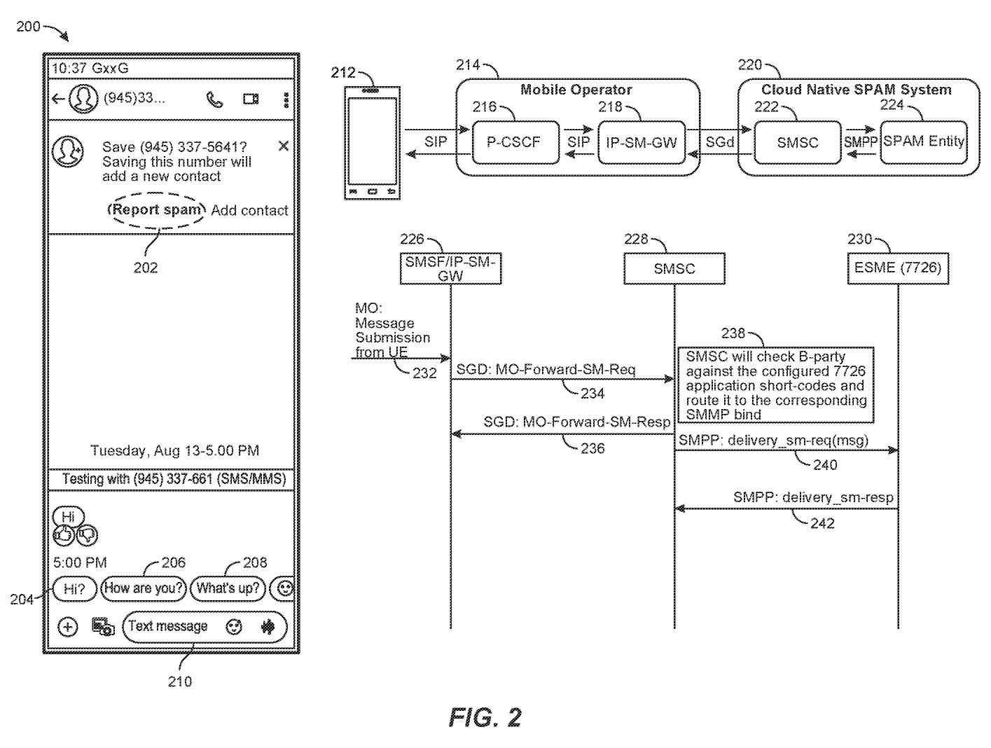

FIG. 2 illustrates an example comprehensive system architecture and message flow for reporting spam in text messages, which serves as a background context for the current techniques related to spam call reporting. This figure showcases a related approach for handling spam in Short Message Service (SMS) communications, providing insight into how spam reporting mechanisms can be implemented in related telecommunications systems. While this disclosure focuses on spam call reporting within a native dialer application, FIG. 2 presents a parallel system for text messages. The figure is divided into three main sections: a user interface panel demonstrating how users might report spam text messages, a network architecture diagram illustrating the backend systems involved in processing these reports, and a timing diagram detailing the sequence of events that occur when a spam report is submitted. FIG. 2 may help to contextualize the innovations presented in the current disclosure, highlighting how the principles of user-driven reporting and network-level processing may be applied to different types of telecommunications services.

In some examples, the left side panel 200 of FIG. 2 may depict a graphical user interface of a smartphone screen, representing the user-facing aspect of the spam reporting system. The interface may display a conversation thread, including several text messages, which may simulate a typical user experience within a messaging application. Below these messages, a prominent report spam button 202 may be presented, offering users a straightforward method to flag unwanted or suspicious messages. This button may be designed to be easily accessible and visually distinct, potentially encouraging more frequent reporting of spam messages by reducing the effort required from users. The placement and design of this button may be helpful in promoting user engagement with the spam prevention system. The conversation thread may include various messages, such as one saying “Hi?” 204, another asking “How are you?” 206, and a third stating “What's up?” 208. These messages may represent a typical conversation flow, providing context for when and how a user might encounter spam and choose to report it. At the bottom of the screen, a text message input element 210 may be displayed, allowing users to compose and send new messages. This layout may demonstrate how the spam reporting function may be integrated into the standard messaging interface, potentially improving user engagement with the spam prevention system. The integration of the reporting feature within the familiar messaging environment may reduce friction in the reporting process, potentially leading to more accurate and timely identification of spam messages.

The top right panel of FIG. 2 may illustrate an example network architecture involved in processing spam reports, showcasing the backend systems that support the user-facing spam reporting feature. A smartphone 212 may be shown communicating with a mobile operator component 214 using the Session Initiation Protocol (SIP). This initial communication may represent the first step in the spam reporting process, where the user's device initiates contact with the network infrastructure. The mobile operator 214 may then communicate with a cloud native spam system 220 using the SGd protocol. This secondary communication may illustrate how different vendor systems within the network may interact to process and route spam reports. Within the mobile operator 214, two sub-elements may be depicted: a Proxy-Call Session Control Function (P-CSCF) 216 and an IP Short Message Gateway (IP-SM-GW) 218. These components may play roles in routing and processing SIP messages within the IP Multimedia Subsystem (IMS) architecture. The cloud native spam system 220 may include a Short Message Service Center (SMSC) 222 and a SPAM Entity 224. The SMSC 222 may be responsible for storing, forwarding, converting and delivering SMS messages, while the SPAM Entity 224 may be specialized in identifying and handling potential spam messages. The communication between these elements may be represented by bidirectional arrows, forming a highway-like structure with top arrows pointing left to right and bottom arrows pointing right to left. This bidirectional flow may indicate the interactions and data exchanges that occur during the example spam reporting and analysis process. This architecture may illustrate how spam reports may be processed and routed through various network components, potentially enabling efficient handling and analysis of reported spam messages.

The bottom right section of FIG. 2 presents a timing diagram that details the sequence of events in the spam reporting process, providing insight into the temporal aspects of how spam reports are handled within the network. The diagram may involve three main components: the Short Message Service Function/IP Short Message Gateway (SMSF/IP-SM-GW) 226, the Short Message Service Center (SMSC) 228, and the External Short Messaging Entity (ESME) 230, which may be associated with the short code 7726 (used for reporting spam).

The SMSF/IP-SM-GW 226 may serve as an interface between the IP-based networks and the traditional SMS infrastructure, facilitating the transmission of messages between these different network types. This component may play a role in ensuring that spam reports originating from IP-based services may be properly processed and forwarded to the appropriate entities in the SMS network. The SMSC 228 may act as a central hub for storing, forwarding, and routing SMS messages within the network. In the context of spam reporting, the SMSC may be responsible for receiving spam reports, processing them according to predefined rules, and directing them to the appropriate spam handling entities.

The ESME (7726) 230 may represent a specialized entity dedicated to handling spam reports. The short code 7726, which spells out "SPAM" on a phone keypad, may be widely recognized and used by users to report unwanted messages. This dedicated ESME may be equipped with advanced spam analysis tools and may be connected to broader spam prevention databases and systems. These components may interact in a specific sequence to process spam reports efficiently. The process may begin with step 232, where the SMSF/IP-SM-GW 226 receives a message submission from a user equipment (UE). This step may represent the initial trigger for the spam reporting sequence, initiated by a user action on their device. This may be followed by step 234, where the SMSF/IP-SM-GW 226 sends a SGD: MO-Forward-SM-Req message to the SMSC 228. This message may contain the information for the SMSC to process the potential spam report, including the reported phone number and possibly the content of the suspicious message.

Upon receiving this request, the SMSC 228 may perform a check, as indicated in step 238, where it may compare the B-party (the recipient's number) against configured 7726 application short-codes and route it to the corresponding SMPP (Short Message Peer-to-Peer Protocol) bind. This step may be helpful in determining whether the reported message meets the criteria for spam and how it should be handled further. The comparison against the 7726 short code may help the SMSC identify that this is indeed a spam report rather than a regular message. The SMSC 228 may then send a response back to the SMSF/IP-SM-GW 226 in step 236, potentially confirming the receipt and initial processing of the spam report. This acknowledgment may ensure that the reporting user's device receives confirmation that their report has been received and is being processed. Finally, in steps 240 and 242, the SMSC 228 and ESME (7726) 230 may exchange SMPP delivery request and response messages. These final steps may represent the routing of the spam report to specialized spam handling entities for further analysis and action. The ESME may then process the report, potentially adding the reported number to a spam database, initiating further investigation, or taking other appropriate actions to mitigate the spread of spam messages.

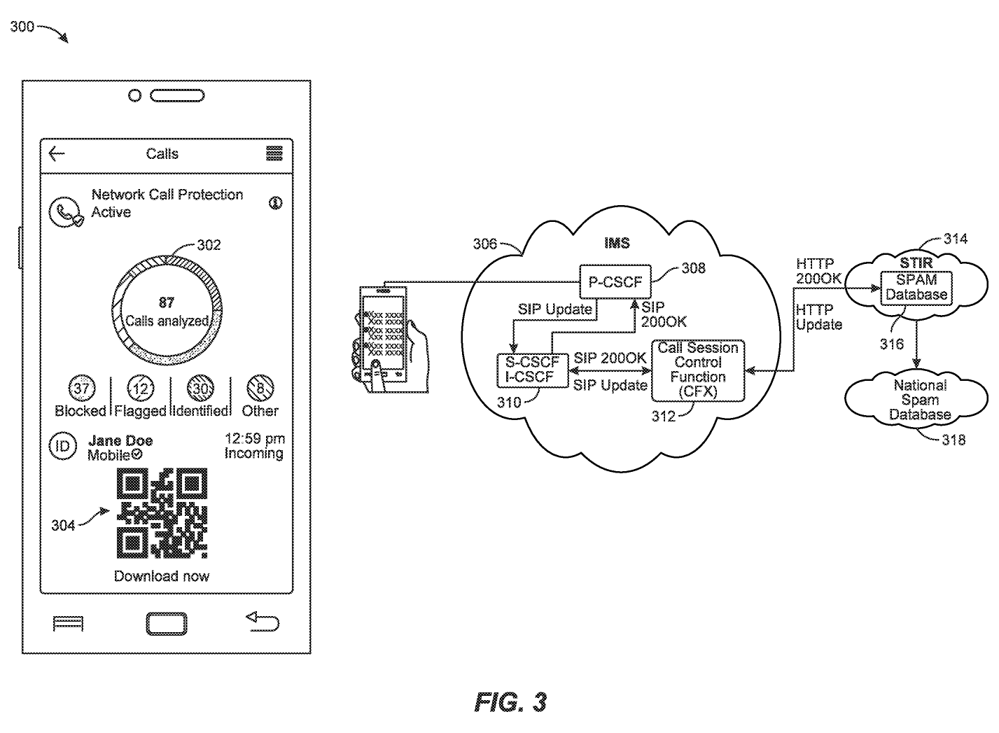

FIG. 3 illustrates an example comprehensive system for spam call detection, reporting, and prevention, showcasing both the user-facing interface and the underlying network architecture. This figure may provide insights into how the spam call reporting technique may be implemented across various layers of a telecommunications system, from user interaction to network-level processing and database management. The integration of these components may offer a holistic solution to the persistent challenge of unwanted calls, potentially enhancing the user experience while simultaneously strengthening the integrity of the telecommunications network. By presenting both the user interface and the backend infrastructure in a single figure, FIG. 3 underscores the interconnected nature of modern spam prevention techniques, highlighting how user actions may trigger complex network processes to identify, report, and mitigate spam calls in real-time.

The left panel of FIG. 3 illustrates an alternative technique for spam call management, providing context and contrast for the system described in this disclosure. This panel depicts a user interface for a standalone application dedicated to call management and spam protection, representing a different approach to addressing unwanted calls. At the top of the interface, the application title Calls may be displayed, immediately followed by a subtitle indicating Network Call Protection Active. This prominent placement may emphasize the active nature of the spam protection feature, potentially reassuring users of ongoing safeguards against unwanted calls. Below this, a circular pie-type chart 302 may visually represent the analysis of 87 calls, providing users with a quick and intuitive overview of their call history. This chart may be further broken down into specific categories, illustrating the disposition of these analyzed calls: 37 calls blocked, 12 calls flagged, 30 calls identified, and 8 calls designated as other. This detailed breakdown may offer users a comprehensive view of how the system is managing their incoming calls, potentially increasing user confidence in the spam protection mechanism.

The interface may also display specific call information, such as Jane Doe mobile with a checkmark, indicating a verified or trusted caller. The timestamp 12:59 PM and the incoming label may provide additional context about the call. This level of detail in the user interface may help users quickly distinguish between legitimate calls and potential spam, enhancing their ability to manage communications effectively. Below this information, a QR code 304 may be presented, accompanied by the text “Download now.” This QR code may represent a method for users to download or update the standalone app, highlighting a key characteristic of this alternative system. The presence of this download option underscores a difference between this approach and another system later described in the current disclosure. While this alternative relies on a separate application that users may need to actively acquire, install, and maintain, in some examples the current system aims to integrate spam reporting functionality directly into the native dialer application. This contrast serves to illustrate the potential advantages of the native integration approach, such as eliminating the need for users to manage additional applications, potentially offering a more seamless and accessible spam prevention experience. By presenting this alternative alongside the current system, FIG. 3 provides a comparative context that may highlight the unique aspects and potential benefits of the native dialer integration technique described in this disclosure.

The right side of FIG. 3 depicts the underlying network architecture that supports an example spam call detection and reporting system that can improve upon the system of the left side panel. This architecture may illustrate the complex backend processes that may occur when a user reports a spam call. At the left of this diagram, a smartphone may represent the user's device, which may initiate the spam reporting process. The smartphone may communicate with a cloud labeled IMS 306, representing the IP Multimedia Subsystem that handles call and spam reporting functions. The IMS framework may serve as an intermediary between user devices and various network services, facilitating the integration of voice, video, and data communications. In the context of spam prevention, the IMS may play a role in processing and routing spam reports, ensuring that user-generated information is efficiently transmitted to the appropriate network components for analysis and action.

Within the IMS cloud 306, several components may be identified, each playing a specific role in the call handling and spam reporting process. The Proxy-Call Session Control Function (P-CSCF) 308 may serve as the first point of contact for the user's device within the IMS network. It may be responsible for authenticating the user's device and establishing secure communication channels, ensuring that spam reports are transmitted safely and reliably. The Serving-Call Session Control Function (S-CSCF) and Interrogating-Call Session Control Function (I-CSCF) 310 may work together to process and route session control signals within the network. These components may be helpful in determining how spam reports are handled and directed within the IMS infrastructure, potentially optimizing the speed and efficiency of the spam reporting process. The Call Session Control Function (CFX) 312 may manage the overall call session, including handling of spam reports. This component may serve as a central coordination point, integrating information from various sources to make decisions about call routing, spam classification, and appropriate responses to user reports.

The diagram may illustrate the flow of information through these components, depicting the interactions that occur during the spam reporting process. An arrow labeled SIP Update may point from the P-CSCF 308 to the S-CSCF/I-CSCF 310, representing the transmission of a spam report from the user's device. This use of the Session Initiation Protocol (SIP) for spam reporting may leverage one or more communication standards, potentially allowing for seamless integration of spam prevention features into related network infrastructures. A return arrow labeled SIP 200 OK may indicate an acknowledgment of the report, ensuring that the user's device receives confirmation that the spam report has been successfully received and processed. Bidirectional arrows between the S-CSCF/I-CSCF 310 and the CFX 312 may suggest ongoing communication and data exchange between these components during the spam reporting process. This continuous interaction may enable real-time updates and adjustments to spam detection algorithms, potentially improving the system's accuracy and responsiveness over time.

To the right of the IMS cloud, a separate cloud labeled STIR 314 is depicted. STIR, which stands for Secure Telephone Identity Revisited, is a protocol used for call authentication and spam prevention. Within this cloud, a SPAM database 316 is shown, potentially serving as a repository for reported spam numbers and related information. The integration of STIR protocols with spam databases may enhance the overall reliability of caller identification, potentially reducing the incidence of spoofed or fraudulent calls. The bidirectional arrow between the CFX 312 and the STIR cloud 314 is labeled HTTP Update and HTTP 200 OK, indicating that spam reports may be sent to and acknowledged by the STIR system using HTTP protocols. This use of standard web protocols for communication between network components may facilitate interoperability and ease of integration with web-based services and databases.

Finally, at the bottom right of the diagram, a cloud labeled National Spam Database 318 may be shown. An arrow pointing from the STIR cloud 314 to this national database indicates that locally reported spam information may be shared with a broader, possibly country-wide database. This sharing of information may enhance the overall effectiveness of spam detection and prevention across multiple networks and regions. The inclusion of a national-level database in the architecture may underscore the collaborative nature of effective spam prevention, potentially enabling more comprehensive and up-to-date spam identification across diverse telecommunications networks and geographical areas. This interconnected approach to spam management may lead to more robust and adaptive spam prevention techniques, potentially benefiting users across multiple service providers and regions.

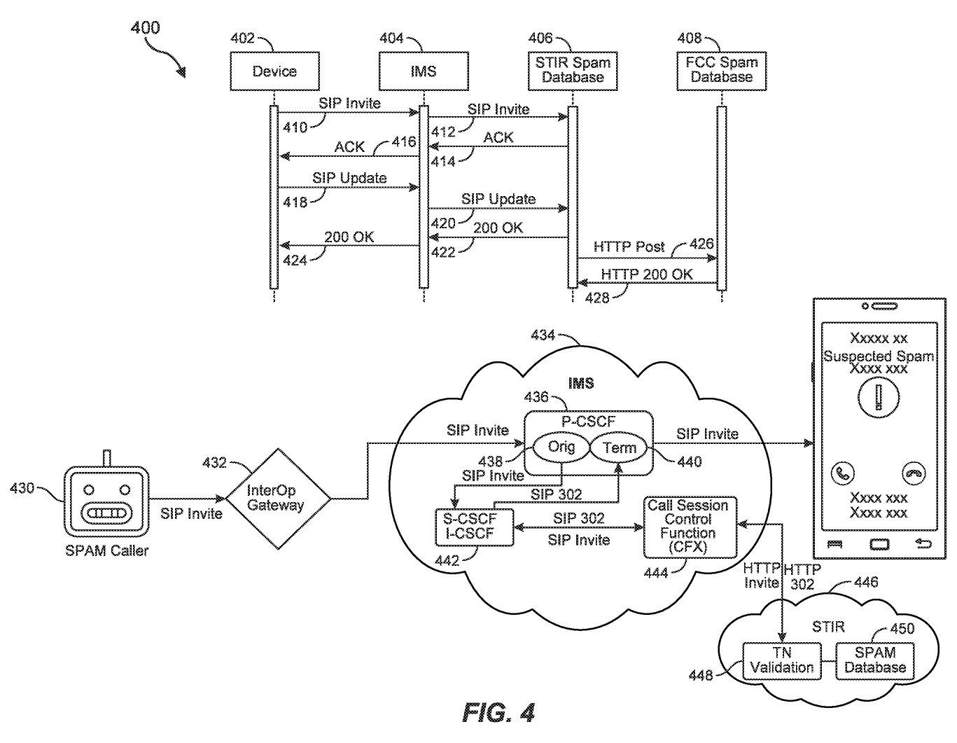

FIG. 4 illustrates an example comprehensive system architecture and sequence diagram for spam call detection, reporting, and prevention, showcasing both the temporal flow of information and the underlying network infrastructure. This figure may provide insights into how the spam call reporting technique may be implemented across various layers of a telecommunications system, from initial call reception to final user notification. The diagram is divided into two main sections: a top panel depicting a sequence diagram and a bottom panel showing the system architecture. These two panels, when considered together, may offer a holistic view of the spam detection and reporting process, highlighting the interactions between various system components and the chronological progression of events during a potentially spam call.

The top panel of FIG. 4 presents a timing or sequence diagram that may detail the interactions between four elements of the spam detection system: Device 402, IMS 404, STIR Spam Database 406, and FCC Spam Database 408. This sequence may illustrate the flow of information and decision-making processes that occur when a potentially spam call is received and reported. The diagram may begin with step 410, where the Device 402 sends a SIP INVITE message to the IMS 404. This initial step may represent the beginning of a call setup process, where the user's device is attempting to establish a connection. The use of Session Initiation Protocol (SIP) in this context may highlight the system's integration with one or more telecommunications protocols, potentially allowing for seamless implementation across various network architectures. Following this, at step 412, the IMS 404 may forward the SIP INVITE to the STIR Spam Database 406. This forwarding action may indicate that the IMS is leveraging the STIR system to verify the authenticity of the incoming call or check if the calling number has been previously reported as spam. The involvement of the STIR Spam Database at this early stage may underscore the proactive nature of the spam detection technique, potentially intercepting suspicious calls before they reach the end-user.

The STIR Spam Database 406 may then respond with an ACK (acknowledgment) message to the IMS 404 at step 414, which may be relayed back to the Device 402 by the IMS 404 at step 416. This exchange of ACK messages may confirm that the spam check request has been received and processed. The inclusion of these acknowledgment steps in the sequence may indicate a robust communication protocol, ensuring that each component in the system is informed of the ongoing processes. Such thorough communication may contribute to the reliability and efficiency of the spam detection technique. The sequence may continue with step 418, where the Device 402 sends a SIP Update message to the IMS 404. This update may potentially contain information about the user's decision to report the call as spam. The ability for the user's device to send updates during an ongoing call may suggest a dynamic and responsive system, capable of adapting to user input in real-time.

The IMS 404 may then forward this SIP Update to the STIR Spam Database 406 at step 420, possibly to update the database with the new spam report. This step may highlight the system's ability to continuously refine and improve its spam detection capabilities based on user feedback. The STIR Spam Database 406 may acknowledge the update with a 200 OK message sent to the IMS 404 at step 422, which may then be relayed back to the Device 402 at step 424. This exchange may confirm that the spam report has been successfully processed and recorded. The use of HTTP status codes (e.g. 200 OK) in this context may indicate the system's adherence to certain web protocols, potentially facilitating integration with other web-based services and systems.

In the final steps of the sequence, the STIR Spam Database 406 may send an HTTP POST request to the FCC Spam Database 408 at step 426. This action may represent the sharing of spam report information with a national-level database, potentially enhancing the reach and effectiveness of the spam detection system. The inclusion of a national database in this process may suggest a collaborative technique to spam prevention, where information gathered from individual users or service providers may contribute to a broader, more comprehensive spam detection network. The FCC Spam Database 408 may then respond with an HTTP 200 OK message at step 428, confirming the successful receipt and processing of the shared information. This final acknowledgment may ensure that the spam report has been properly propagated throughout the system, from the individual user's device to a national-level database.

The bottom panel of FIG. 4 depicts an example architecture diagram that may illustrate the various components involved in the spam detection and reporting process. From left to right, the diagram shows a SPAM Caller 430, which may represent the source of an unwanted call. This component in the diagram may serve to illustrate how the system handles incoming calls from potentially malicious sources. The call may be routed through an InterOp Gateway 432, which may serve as an intermediary between different network types or protocols. The inclusion of this gateway may highlight the system's ability to operate across diverse network environments, potentially increasing its effectiveness in detecting spam calls originating from various sources.

The call may then enter the IMS cloud 434, which houses several components of the spam detection system. Within the IMS 434, the diagram shows a P-CSCF 436 with two circles labeled Orig and Term, representing originating and terminating call functions. The presence of both originating and terminating functions within the P-CSCF may indicate the system's ability to handle spam detection for both incoming and outgoing calls, providing comprehensive protection for users. The S-CSCF/I-CSCF 442 may be responsible for session control and routing within the IMS, while the Call Session Control Function (CFX) 444 may manage overall call processing and decision-making. These components may work in concert to efficiently route calls and apply spam detection algorithms at various stages of the call process.

Between the IMS 434 and the smartphone GUI on the right side of the diagram, a STIR cloud 446 is depicted. Within this STIR cloud, two components are shown: TN Validation 448 and SPAM Database 450, connected by a horizontal line. These components may play crucial roles in validating caller identities and maintaining records of reported spam numbers. The TN Validation component may be responsible for verifying the authenticity of the calling party's telephone number, potentially using cryptographic techniques to detect spoofed or falsified caller IDs. The SPAM Database may serve as a repository for known spam numbers, continuously updated based on user reports and system analysis.

The message flow illustrated in this architecture diagram may provide insights into how a potentially spam call is processed and evaluated. A SIP INVITE message may be shown traveling from the SPAM Caller 430 through the InterOp Gateway 432 and into the P-CSCF 436. From there, it may be forwarded to the S-CSCF/I-CSCF 442. A SIP 302 message (possibly indicating a redirect or further processing needed) may then be sent from the S-CSCF/I-CSCF 442 back to the P-CSCF 436 (Term). This flow of messages may demonstrate how the system may redirect or apply additional scrutiny to calls that are suspected of being spam.

The diagram may also show bidirectional communication between the S-CSCF/I-CSCF 442 and the CFX 444, with SIP 302 and SIP INVITE messages exchanged. This interaction represents the decision-making process for handling the potentially spam call, possibly involving algorithms that take into account various factors such as call origin, frequency, and user feedback. Another bidirectional arrow may be shown between the CFX 444 and the TN Validation 448 component of the STIR cloud, with HTTP INVITE and HTTP 302 messages exchanged. This communication may indicate the process of validating the calling number and checking it against spam databases, potentially involving cryptographic verification of the caller's identity.

Finally, the smartphone GUI on the right side of the diagram may display "Suspected Spam," alerting the user to the possibility that the incoming call may be unwanted. This user-facing element of the system may represent the culmination of the spam detection process, where the results of the various checks and validations are presented to the end-user in a clear and actionable format. The prominence of this warning on the user's device may empower individuals to make informed decisions about whether to answer calls, potentially reducing the impact of spam and unwanted communications.

In some examples, this architecture may enable the transmission of a Session Initiation Protocol (SIP) update message from a native dialer application to an IP Multimedia Subsystem (IMS) that includes information identifying a calling party number as spam. The IMS may then update a spam database with this information, potentially improving future spam detection capabilities. The inclusion of both local (STIR) and national (FCC) spam databases in the system may allow for comprehensive spam prevention across multiple networks and regions. This multi-tiered database technique may provide several potential benefits. Firstly, it may allow for rapid, localized spam detection and prevention, as the STIR database may be quickly updated and accessed by the IMS. Secondly, the sharing of information with the national FCC database may contribute to a broader, more robust spam prevention network that extends beyond individual service providers. This collaborative technique may be particularly effective in combating large-scale spam operations that target multiple networks or regions.

The architecture depicted in FIG. 4 may also illustrate how the system may handle incoming calls from various sources, including potential spam callers. The inclusion of the InterOp Gateway 432 in the diagram indicates that the system is capable of processing calls from diverse network types, potentially increasing its effectiveness in identifying and mitigating spam calls regardless of their origin. This interoperability may be helpful in addressing the evolving nature of spam calls, which may originate from a wide range of sources and utilize various technologies to bypass detection.

Furthermore, the detailed sequence diagram in the top panel of FIG. 4 may demonstrate the system's ability to perform real-time spam checks and updates. This real-time processing capability may be valuable in the context of spam call prevention, as it may allow the system to identify and flag potential spam calls before they reach the end-user. Additionally, the ability for users to report spam calls during or immediately after the call, as indicated by the SIP Update message in step 418, may contribute to the system's ability to rapidly adapt to new spam techniques and maintain an up-to-date database of known spam numbers.

In some examples, the system may leverage the STIR (Secure Telephone Identity Revisited) protocol, as indicated by the STIR cloud 446 in the architecture diagram. This protocol may provide additional layers of security and authentication in the call handling process. The TN Validation 448 component within the STIR cloud may play a role in verifying the authenticity of calling party numbers, potentially using cryptographic techniques to detect spoofed or manipulated caller IDs. This validation process may enhance the system's ability to accurately identify and flag spam calls, particularly those that attempt to evade detection by using falsified caller information.

The integration of spam detection and reporting functionalities directly into the native dialer application, consistent with the smartphone GUI in the diagram, may offer several advantages. It may provide a more seamless user experience, allowing individuals to easily report spam calls without the need for separate applications or complex procedures. This integration may potentially lead to increased user engagement in spam reporting, which in turn may enhance the overall effectiveness of the spam detection system. Moreover, the prominent display of "Suspected Spam" on the user interface may empower users to make informed decisions about incoming calls, potentially reducing the impact of unwanted communications on individuals and networks alike.

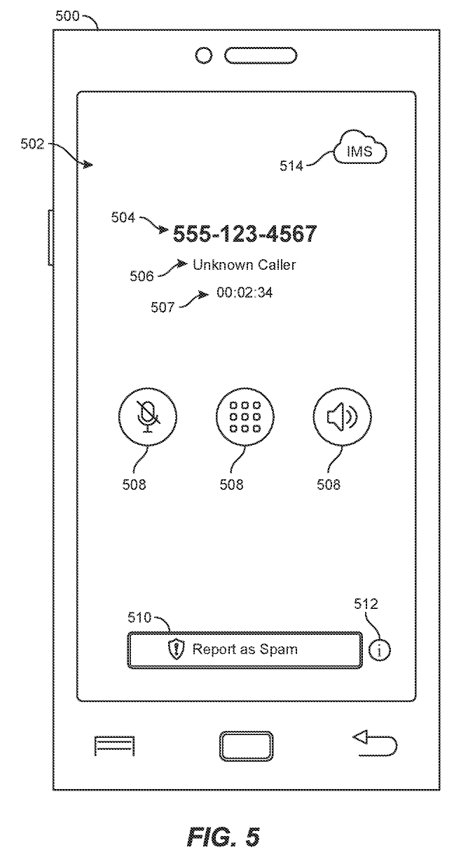

FIG. 5 illustrates an example user interface for spam reporting within a native dialer application during an active call. The figure presents a modern smartphone outline 500, which resembles current popular models. Within the smartphone outline 500, a screen 502 is shown. The screen displays the native dialer application interface, which is designed to provide users with an intuitive and easily navigable layout for managing calls and reporting spam. By integrating the spam reporting feature directly into the native dialer application, users may access this functionality without the need for additional software or complex navigation, potentially increasing the likelihood of user engagement with the spam reporting system.

At the top of the screen, the calling party information 504 is prominently displayed. This information includes a large, bold text showing a phone number (e.g., "555-123-4567"), which represents the number of the incoming call. Directly beneath this, in slightly smaller text, the label "Unknown Caller" 506 is shown. This combination of information quickly conveys to the user that the incoming call is from an unrecognized number, potentially alerting them to exercise caution or consider using the spam reporting feature. The clear presentation of this information helps users make informed decisions about how to handle the call. The prominence of the calling party information 504 and the "Unknown Caller" label 506 underscores the importance of providing users with immediate and clear identification of potential spam calls.

Just below the caller information, a small call duration timer 507 is displayed, showing the length of the ongoing call (e.g., "00:02:34"). This timer provides users with context about the duration of their interaction with the potential spam caller, which may be useful information when deciding whether to report the call as spam. The presence of this timer also serves as a reminder that the call is active, potentially helping users remain aware of their call status while navigating the interface. The inclusion of the call duration timer 507 demonstrates attention to detail in the user interface design, acknowledging that the length of a call may be a relevant factor in determining whether it is spam. This feature may assist users in making more informed decisions about reporting calls, potentially improving the accuracy of spam identification.

In the middle of the screen, three circular call control buttons 508 are arranged in a horizontal row. Each button contains a simple icon representing its function: a microphone icon with a slash through it for mute, a grid of nine dots for the keypad, and a speaker icon for speakerphone. These controls provide users with quick access to call management functions, allowing them to adjust their call settings as desired while still maintaining easy access to the spam reporting feature. The clear and universally recognizable icons contribute to a user-friendly interface that requires minimal cognitive load to operate. The placement and design of these call control buttons 508 demonstrate a thoughtful balance between providing necessary call management tools and maintaining focus on the spam reporting feature. By offering familiar call controls in a compact and easily accessible format, the interface allows users to manage their calls effectively while keeping the spam reporting option prominently in view.

At the bottom of the screen, a rectangular "Report as Spam" button 510 spans most of the screen's width. The button contains clear text reading "Report as Spam," with a small icon of a shield with an exclamation mark inside positioned to the left of the text. This button's size and placement make it easily discoverable and accessible to users, potentially encouraging more frequent reporting of spam calls. The shield icon visually reinforces the protective nature of the spam reporting action, possibly motivating users to engage with the feature. The design and positioning of the "Report as Spam" button 510 highlight its function within the interface, making it a focal point for user interaction. The use of a shield icon with an exclamation mark may evoke a sense of security and urgency, potentially encouraging users to take action against suspected spam calls.

To the right of the "Report as Spam" button, a small circular information icon 512 with an "i" inside is displayed. This icon provides users with access to additional information about the spam reporting feature, potentially helping them understand how the system works and what happens when they report a call as spam. The inclusion of this information option may contribute to user trust and engagement with the spam reporting system. The information icon 512 demonstrates an understanding of the need for transparency and user education in the spam reporting process. By offering easy access to additional information, the interface may help users feel more confident in their use of the feature and more invested in contributing to the overall spam prevention effort.

In the top-right corner of the screen, a small IMS indicator 514 is shown, represented by a cloud icon with "IMS" written inside. This indicator informs users that their device is connected to the IP Multimedia Subsystem, potentially providing reassurance that the spam reporting feature is active and functioning. The presence of this indicator also communicates the sophisticated network infrastructure supporting the spam reporting system, possibly enhancing user confidence in the feature's effectiveness. The IMS indicator 514 serves as a visual cue for the underlying technology powering the spam reporting feature, potentially increasing user trust in the system's capabilities and reliability.

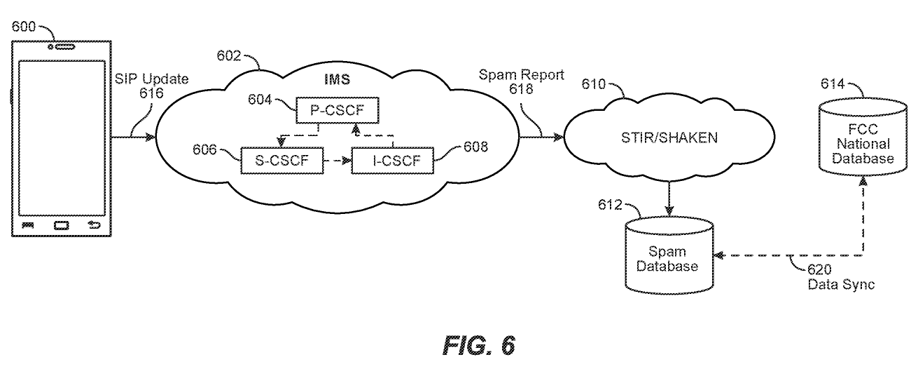

FIG. 6 illustrates an example schematic diagram of the system architecture for the spam reporting feature. FIG. 6 and the right side of FIG. 3 both illustrate aspects of an example spam reporting system architecture, but they differ in their focus and level of detail. FIG. 6 provides a more comprehensive and abstract view of the entire system, showcasing the flow of information from the user's device through various network components to national databases. It emphasizes the broader ecosystem of spam reporting, including the interaction between local and national databases. In contrast, the right side of FIG. 3 offers a more detailed look at the internal structure of the IMS (IP Multimedia Subsystem) and its interaction with the STIR/SHAKEN system. FIG. 3 highlights specific components within the IMS, such as the P-CSCF, S-CSCF, and I-CSCF, and shows how they interact with the Call Session Control Function (CFX). This more granular view in FIG. 3 may provide insights into the precise routing and processing of spam reports within the IMS infrastructure. While FIG. 6 illustrates the overall flow of information, FIG. 3 delves into the mechanics of how that information is handled within network components. Together, these figures may offer a complementary perspective on the spam reporting system, with FIG. 6 providing the "big picture" view and FIG. 3 offering a "zoomed-in" look at certain components. This dual representation may help in understanding both the overall architecture and the specific processes involved in spam call reporting and prevention.

The diagram of FIG. 6 presents an example comprehensive view of the various components involved in the spam reporting process, from the user's device to the national database. The layout of the diagram flows from left to right, visually representing the progression of information through the system. This arrangement may help viewers understand the sequence of events and interactions that occur during the spam reporting process. On the left side of the diagram, a simplified smartphone icon represents the User Equipment (UE) 600. This icon symbolizes the user's device with the native dialer application, serving as the starting point for the spam reporting process. The UE 600 may be the primary interface through which users interact with the spam reporting feature, initiating the flow of information through the system. In some examples, the native dialer application within the UE 600 may provide users with an intuitive and easily accessible feature for reporting suspected spam calls. The integration of the spam reporting feature directly into the native dialer application may contribute to increased user engagement and more frequent reporting of spam calls. The UE 600 may also include additional functionality to enhance the user experience, such as the ability to display real-time updates on the status of submitted spam reports or to provide users with feedback on the overall effectiveness of their contributions to the spam prevention system. These features may further encourage user participation and may help to create a more robust and comprehensive spam detection network.

At the center of the diagram, a large cloud shape labeled "IMS" represents the IP Multimedia Subsystem 602. The IMS 602 serves as a central hub for processing and routing the spam reports. Within this cloud, three boxes arranged in a triangular formation represent key components of the IMS: the Proxy-Call Session Control Function (P-CSCF) 604, the Serving-Call Session Control Function (S-CSCF) 606, and the Interrogating-Call Session Control Function (I-CSCF) 608. These components may work in concert to handle the routing and processing of SIP messages within the IMS infrastructure. In some examples, the P-CSCF 604 may act as the first point of contact for the UE 600 within the IMS network, while the S-CSCF 606 and I-CSCF 608 may manage session control and routing functions. The triangular arrangement of these components within the IMS cloud indicates interconnected roles in processing spam reports. The IMS 602 may employ algorithms to analyze incoming spam reports, potentially correlating them with historical data and patterns to improve the accuracy of spam detection. Additionally, the IMS 602 may incorporate machine learning techniques that allow it to adapt and refine its spam detection capabilities over time, based on the continuous influx of user reports and system-generated data. This adaptive capability may enable the spam reporting system to stay ahead of evolving spam tactics and techniques, providing users with more effective protection against unwanted calls.

A solid arrow labeled "SIP Update" 616 connects the UE 600 to the IMS cloud 602. This arrow represents the transmission of a Session Initiation Protocol (SIP) update message from the native dialer application to the IMS. In some examples, this SIP update message may contain information about a suspected spam call, including the calling party number and any additional details provided by the user. The use of SIP for transmitting spam reports may leverage one or more telecommunications protocols, potentially allowing for seamless integration of the spam reporting feature into network infrastructures. The SIP Update 616 may include various data points beyond just the caller's number, such as call duration, time of day, and any user-provided categorization of the suspected spam (e.g., telemarketing, scam, robocall). This rich data set may enable more nuanced analysis and categorization of spam calls, potentially improving the system's ability to identify and block similar calls in the future. Furthermore, the SIP Update 616 may be encrypted to ensure the privacy and security of user-submitted data, addressing potential concerns about the confidentiality of personal information shared through the spam reporting process.

Dotted arrows between the P-CSCF 604, S-CSCF 606, and I-CSCF 608 boxes within the IMS cloud 602 indicate internal communication and data exchange between these components. These interconnections may facilitate the efficient processing and routing of spam reports within the IMS infrastructure. In some examples, this internal communication may involve the validation of spam reports, the application of spam detection algorithms, or the coordination of responses to reported spam calls. The dotted arrows may represent a network of interactions, potentially including load balancing mechanisms to distribute the processing of spam reports across multiple nodes, redundancy systems to ensure continuous operation in case of component failure, and real-time data synchronization to maintain consistency across the IMS infrastructure. This robust internal architecture may contribute to the scalability and reliability of the spam reporting system, allowing it to handle large volumes of reports while maintaining low latency and high accuracy in spam detection.

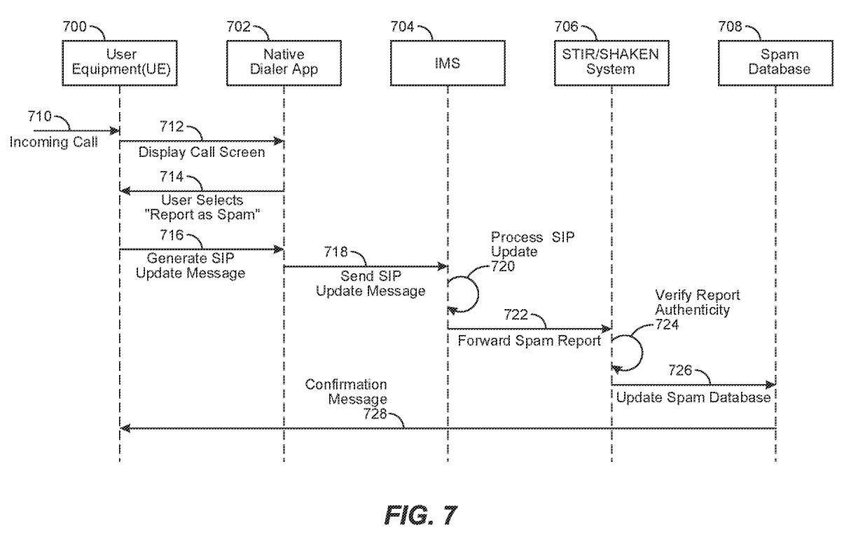

FIG. 7 presents an example detailed sequence diagram illustrating the step-by-step process of reporting a spam call. The diagram is oriented vertically, with time flowing from top to bottom, providing a clear chronological view of the spam reporting process. This visual representation may allow for a comprehensive understanding of the interactions between various system components and the flow of information from the user's initial action to the final database update. The diagram includes five main entities represented by vertical lines running the full height of the diagram: User Equipment (UE) 700, Native Dialer App 702, IMS 704, STIR/SHAKEN System 706, and Spam Database 708. These entities represent components involved in the spam reporting process, from the user's device to the backend systems responsible for processing and storing spam reports. The UE 700 may represent any device capable of making and receiving calls, such as smartphones, tablets, or other mobile devices. The Native Dialer App 702 may be integrated directly into the device's operating system, providing a seamless user experience without the need for additional software installations. The IMS 704 may serve as the central hub for processing and routing calls and spam reports within the telecommunications network. The STIR/SHAKEN System 706 may provide additional layers of authentication and verification to ensure the integrity of spam reports. The Spam Database 708 may store and manage information about known spam numbers, potentially serving as a resource for future call screening and spam prevention efforts.

The sequence of events begins with an incoming call 710, represented by an arrow from the left margin to the UE 700. This initial event may trigger the subsequent actions in the spam reporting process. Following the incoming call, the UE 700 displays the call screen 712, illustrated by an arrow from the UE 700 to the Native Dialer App 702. This step may represent the user interface presented to the user when receiving a call, potentially including options for answering, declining, or reporting the call as spam. The user's interaction with this interface may play a role in initiating the spam reporting process. The display of the call screen may involve various elements designed to help users quickly identify potential spam calls, such as caller ID information, warning indicators for suspected spam numbers, or visual cues based on previous user reports. In some examples, the call screen may also display additional context about the incoming call, such as the caller's location, the type of number (e.g., landline, mobile, VoIP), or any available reputation scores associated with the calling number. This rich set of information may empower users to make more informed decisions about whether to answer the call or report it as spam.

The next event in the sequence shows the user selecting the "Report as Spam" option 714, depicted by an arrow from the Native Dialer App 702 to the UE 700. This action may represent the user's decision to flag the incoming call as potential spam, triggering the subsequent steps in the reporting process. The user's ability to easily report suspected spam calls directly from the native dialer interface may contribute to increased user engagement and more frequent reporting of spam calls. In response to the user's selection, the UE 700 generates a SIP Update message 716, shown by an arrow from the UE 700 to the Native Dialer App 702. This step may involve compiling relevant information about the suspected spam call, such as the calling party number, call duration, and any additional details provided by the user. The generation of the SIP Update message may also include the incorporation of device-specific information, such as the user's anonymized identifier, device type, or network connection details, which may help in analyzing patterns of spam activity across different user segments or network conditions. In some examples, the SIP Update message may also include a confidence score or certainty level indicated by the user, allowing for more nuanced processing of spam reports based on the user's perceived reliability of their assessment.

The Native Dialer App 702 then sends the SIP Update message 718 to the IMS 704, represented by an arrow between these two entities. This transmission may leverage existing telecommunications protocols to seamlessly integrate the spam reporting feature into the network infrastructure. The IMS 704 processes the SIP Update 720, illustrated by a self-referential arrow on the IMS line. This processing step may involve various actions such as validating the received information, applying initial spam detection algorithms, or preparing the data for further analysis by the STIR/SHAKEN system. The processing of the SIP Update within the IMS may also include cross-referencing the reported number with existing databases of known legitimate numbers (e.g., emergency services, government agencies, or verified businesses) to reduce false positives in spam reporting. Additionally, the IMS may apply machine learning algorithms to analyze the reported call in the context of historical data, network-wide calling patterns, and/or user behavior models to assess the likelihood of the call being spam. This multi-faceted analysis may contribute to a more accurate and reliable spam detection system.

Following the processing of the SIP Update, the IMS 704 forwards the spam report 722 to the STIR/SHAKEN System 706, shown by an arrow between these components. This step may involve the transmission of the processed spam report to a specialized system designed to authenticate caller identities and verify the legitimacy of the report. The STIR/SHAKEN System 706 then verifies the report authenticity 724, represented by a self-referential arrow on its timeline. This verification process may employ advanced cryptographic techniques to ensure the integrity and reliability of the spam report. The verification step may include checking the digital signatures associated with the call, validating the chain of trust for the calling number, and assessing the reputation of the originating service provider. In some examples, the STIR/SHAKEN System may also perform additional checks, such as analyzing the frequency of reports for the given number across multiple network providers or comparing the reported behavior with known spam call patterns. This comprehensive verification process may help in distinguishing between genuine spam calls and potential false reports, thereby maintaining the accuracy and trustworthiness of the spam prevention system.

Once the report has been verified, the STIR/SHAKEN System 706 updates the Spam Database 708, illustrated by an arrow between these entities. This step may involve adding the reported number to a list of known spam callers, updating existing records, and/or adjusting spam likelihood scores based on the new information. The integration of the spam report into the database may contribute to the ongoing refinement and improvement of the spam detection system. The update process may also trigger additional actions, such as sharing the verified spam report with partner networks or regulatory bodies, initiating further investigation into the reported number, and/or adjusting network-wide spam filtering rules based on emerging patterns. In some examples, the Spam Database may employ advanced data analytics techniques to identify correlations between reported spam numbers, such as common prefixes, number ranges, or geographical origins, which may lead to more proactive spam prevention measures.

The final step in the sequence shows a confirmation message 728 being sent from the Spam Database 708 back to the UE 700, passing through the STIR/SHAKEN System 706 and IMS 704. This confirmation may provide feedback to the user, acknowledging the successful processing and storage of their spam report. The inclusion of this confirmation step may enhance the user experience by providing closure to the reporting process and potentially increasing user confidence in the system's effectiveness. The confirmation message may contain various types of information, such as a summary of the action taken, the current status of the reported number in the spam database, or aggregated statistics about how many other users have reported the same number. In some examples, the confirmation may also include educational content about spam prevention best practices or updates on new features in the spam reporting system. This two-way communication may foster a sense of community engagement in spam prevention efforts and may encourage users to continue actively participating in the reporting process.

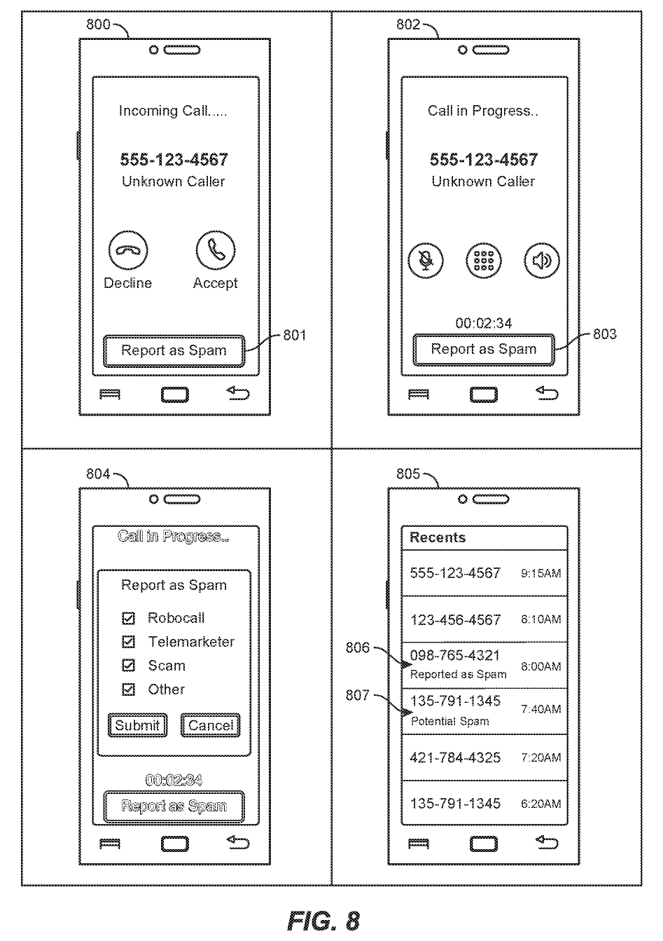

FIG. 8 illustrates a comprehensive user experience flow for spam reporting and management within a native dialer application. The figure is divided into four panels, arranged in a 2x2 grid, each representing a different screen or state of the native dialer application. This layout provides a clear visual progression of the spam reporting process, from the initial incoming call to the management of reported spam numbers. By depicting multiple stages of the spam reporting process, FIG. 8 may demonstrate the seamless integration of these features into the native dialer app, potentially highlighting the user-friendly nature of this spam prevention technique.

The top-left panel of FIG. 8 shows a smartphone screen 800 displaying an incoming call from an unknown number. The phone number is prominently displayed at the top of the screen, immediately drawing the user's attention to the potential source of the call. Below the number, two large buttons labeled "Answer" and "Decline" are shown, providing the user with primary call handling options. At the bottom of the screen, a smaller "Report as Spam" button 801 is included. This layout may offer users a quick and intuitive way to report suspicious calls without needing to answer them. The inclusion of the "Report as Spam" button 801 on the incoming call screen may enable users to flag potential spam calls proactively, potentially contributing to more timely and accurate spam identification. The prominent display of the unknown number may help users make informed decisions about whether to answer the call or report it as spam, while the clear layout of the action buttons may facilitate easy navigation and quick response to incoming calls.

The top-right panel depicts the same smartphone screen 802, now showing the call in progress. This screen includes standard in-call controls such as mute, keypad, and speaker options, providing users with typical call management functionalities. At the bottom of the screen, a prominent "Report as Spam" button 803 is displayed, allowing users to report the call as spam even while the conversation is ongoing. Above this button, a call timer is shown, which may help users track the duration of the call. The inclusion of the "Report as Spam" button 803 during an active call may enable users to report spam calls that may not have been immediately apparent at the start of the conversation. This feature may be particularly useful for identifying sophisticated spam calls that may initially seem legitimate. The presence of standard call controls alongside the spam reporting option may demonstrate the seamless integration of spam prevention features into the regular call interface, potentially enhancing the user experience by providing all necessary functions in one cohesive layout.

The bottom-left panel shows a smartphone screen 804 displaying a pop-up dialog titled "Report as Spam". This dialog includes checkboxes for different spam categories: "Robocall", "Telemarketer", "Scam", and "Other". Below these options, "Submit" and "Cancel" buttons are included. The background behind the pop-up is dimmed, indicating that it is a modal dialog. This detailed reporting interface may allow users to provide more specific information about the nature of the spam call, potentially improving the accuracy of spam classification and prevention efforts. The inclusion of multiple spam categories may help in creating a more nuanced database of spam calls, which may in turn lead to more effective filtering and blocking of unwanted calls. The modal dialog design may ensure that users focus on the reporting task without distractions, potentially increasing the likelihood of complete and accurate spam reports.

The bottom-right panel illustrates a smartphone screen 805 showing a list of recent calls in the native dialer app. One of the entries, preferably in the middle of the list, displays a phone number with a small "Reported as Spam" label 806 next to it. Below this entry, another number is shown with a "Potential Spam" label 807, indicating it was reported by other users. This call log interface may provide users with a quick overview of their recent call history, including information about previously reported spam calls and potential spam numbers identified by the community. The inclusion of spam status labels in the call log may help users quickly identify and manage potentially unwanted calls, even after the fact. This feature may be particularly useful for users who may not have immediately recognized a call as spam but later wish to report it or review their call history for suspicious patterns.

In some examples, the native dialer application may include additional features to enhance the spam reporting and management experience. For instance, the application may provide users with the ability to block numbers directly from the call log, set personalized spam filters based on their reporting history, or view detailed statistics about spam call trends affecting their number. The application may also incorporate machine learning algorithms that analyze user behavior and reporting patterns to improve spam detection accuracy over time. These advanced features may contribute to a more robust and personalized spam prevention system, potentially increasing user engagement and satisfaction with the native dialer application.

In some examples, the spam reporting interface may include options for users to provide additional context or comments about the reported spam call. This extra information may be valuable for improving spam detection algorithms and identifying new spam tactics. The application may also offer users the ability to review and edit their past spam reports, potentially allowing for the correction of mistaken reports or the addition of new information as it becomes available. Furthermore, the native dialer app may incorporate real-time spam warning features, such as displaying a warning message or changing the ringtone for incoming calls from numbers that have been reported as spam by other users in the community. These features may provide users with more control over their call management and contribute to a more effective collective defense against spam calls.

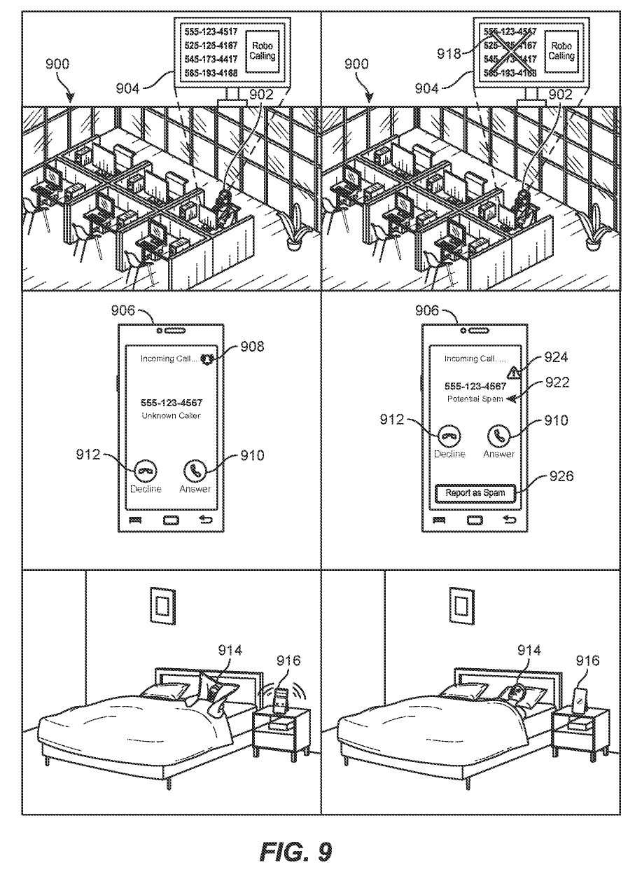

FIG. 9 shows an example side-by-side comparison of spam call targeting and prevention. The figure is divided into six panels, arranged in a 3x2 grid, illustrating the contrast between scenarios with and without spam call prevention techniques. The left side of the figure depicts the process of spam call targeting, while the right side shows how these unwanted calls may be prevented, providing a visual representation of the potential benefits of integrated spam prevention features. This comparative layout may offer viewers a clear understanding of the potential improvements in user experience that spam prevention techniques may provide.

In the top-left panel, a large call center 900 is shown, filled with rows of desks and computers. This setting may represent the origin point of many spam and robocalls. A malicious-looking operator 902 is depicted wearing a headset and sitting at a computer 904. The computer screen displays multiple phone numbers, which may suggest the use of automated dialing or robocalling techniques. This visual representation may help to illustrate the scale and systematic nature of spam call operations, highlighting the challenge that spam prevention systems may face in protecting users from unwanted calls. The depiction of a large-scale call center environment may also suggest the potential for spam calls to originate from organized operations rather than isolated individuals, underscoring the desire for sophisticated spam prevention techniques capable of addressing large-volume call campaigns. The panel may further serve to emphasize the potentially harmful intent behind spam calls, which may range from minor annoyances to more serious attempts at fraud or identity theft. The multiple phone numbers displayed on the computer screen 904 may indicate the use of number spoofing techniques, which may further complicate the task of identifying and blocking spam calls.

The middle-left panel shows a smartphone screen 906 displaying an incoming call from an unknown number. The screen includes a generic ringtone icon 908 and standard "Answer" and "Decline" buttons 910 and 912. This panel may represent the typical user experience when receiving a potential spam call without any preventive measures in place. The lack of any warning or additional context about the incoming call may leave users uncertain about whether to answer or decline, potentially exposing them to unwanted or fraudulent communications. This scenario may underscore the desire for more informative call screening features that could help users make informed decisions about incoming calls from unknown numbers. The generic nature of the incoming call display may highlight the limitations of basic caller ID systems in the face of sophisticated spam techniques. Users may find themselves in a dilemma, weighing the potential importance of answering an unknown call against the risk of exposing themselves to spam or scams. This uncertainty may lead to increased stress and decreased overall satisfaction with the phone service, potentially motivating the development and implementation of more advanced spam prevention features.

In the bottom-left panel, a person 914 is shown in bed, looking frustrated and covering their ears with a pillow. A loudly ringing smartphone 916 is depicted on a bedside table, with its screen lit up and displaying an unknown number. This scene may illustrate the potential disturbance and annoyance caused by spam calls, particularly when they occur at inconvenient times. The visual representation of the user's discomfort may emphasize the impact of unwanted calls on quality of life and the desire for effective spam prevention techniques. This panel may also suggest the potential for spam calls to disrupt sleep or other important activities, further highlighting the value of robust call screening and spam prevention features. The nighttime setting of this panel may emphasize the 24/7 nature of spam call operations, which may not respect typical business hours or time zones. This disregard for the recipient's convenience may contribute to the overall negative impact of spam calls on user experience and well-being. The frustrated expression of the person 914 may also suggest the cumulative effect of repeated spam calls, potentially leading to increased stress, decreased productivity, and a general sense of intrusion into personal time and space.

The top-right panel depicts the same call center 900 and operator 902 as in the top-left panel, but with a key difference. An "X" or prohibition symbol is overlaid on the computer screen 918, suggesting blocked or failed call attempts. This visual may represent the effectiveness of spam prevention techniques in stopping unwanted calls at their source. By showing the spam call operation encountering resistance, this panel may illustrate how integrated spam prevention features could reduce the volume of unwanted calls reaching users. The contrast between this panel and its counterpart on the left side may help to show the potential impact of implementing robust spam detection and blocking mechanisms. As call blocking becomes more prevalent and successful, spam callers may find their efforts increasingly futile, potentially leading to a reduction in overall spam call volume. The red "X" symbol on the computer screen 918 may also represent the cumulative effect of user reports and network-level spam detection, showcasing how collaborative efforts between users and service providers may contribute to a more effective spam prevention ecosystem.

In the middle-right panel, a smartphone screen 920 is shown with an incoming call labeled "Potential Spam" 922. The screen displays a distinct warning icon 924 and a prominent "Report Spam" button 926 alongside standard call controls. This interface may represent an enhanced user experience with integrated spam prevention features. The clear labeling of the call as potential spam and the inclusion of a dedicated reporting button may empower users to make informed decisions about incoming calls and contribute to the ongoing improvement of spam detection systems. This panel may illustrate how spam prevention techniques could provide users with more control and information when handling incoming calls from unknown or suspicious numbers. The warning icon 924 may serve as a quick visual cue, allowing users to quickly assess the nature of the incoming call without needing to read detailed text. This may be particularly helpful in situations where the user desires to make rapid decisions about whether to answer a call. The "Report Spam" button 926 may encourage user participation in the spam prevention process, potentially creating a more collaborative and effective system for identifying and blocking unwanted calls. By making the reporting process easily accessible directly from the call screen, users may be more likely to contribute to the ongoing refinement of spam detection algorithms.

The bottom-right panel shows the same person 914 as in the bottom-left panel, but this time sleeping peacefully in bed. The smartphone 916 on the bedside table is depicted with its screen dark, indicating no disturbance. This scene may illustrate the potential positive impact of effective spam prevention techniques on user well-being. By showing the user undisturbed by unwanted calls, this panel may suggest how spam prevention features could contribute to a more peaceful and less intrusive communication experience. The contrast between this panel and its counterpart on the left side may help to show the potential quality-of-life improvements that could result from implementing robust spam call prevention techniques. The dark screen of the smartphone 916 may represent not only the absence of spam calls but also the user's increased trust in their device's ability to filter out unwanted communications. This trust may lead to reduced anxiety about potential disturbances and may allow users to more fully relax during their personal time. The peaceful sleep depicted in this panel may also suggest broader implications for user health and well-being, as uninterrupted rest may contribute to improved physical and mental health outcomes.

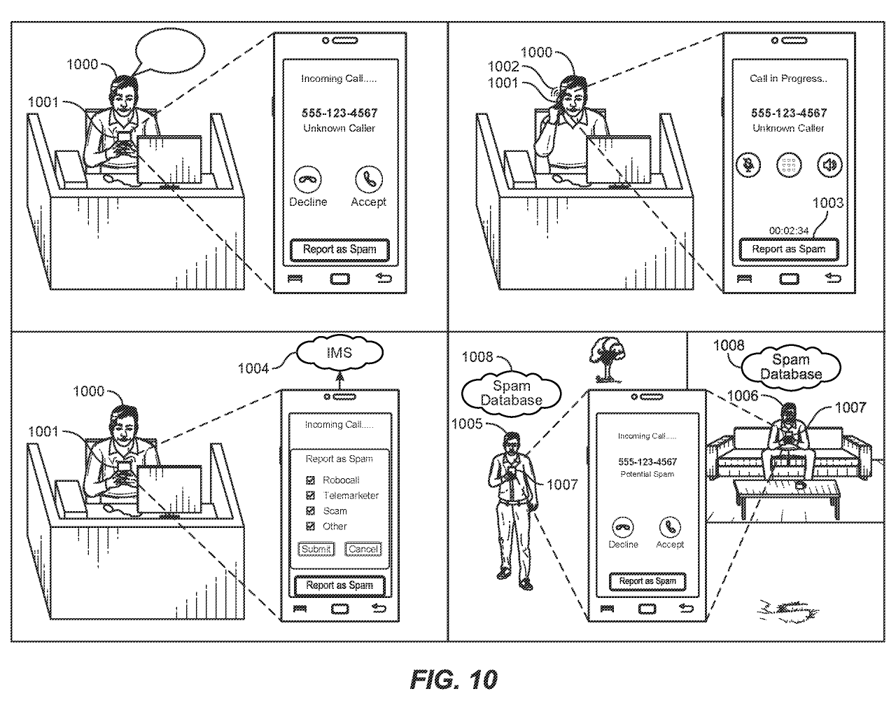

FIG. 10 shows an example real-world scenario of spam call reporting and prevention. The figure is divided into four panels, arranged in a 2x2 grid, illustrating the progression of events related to spam call reporting and prevention. This visual representation may provide insights into how the spam reporting system may function in practical, everyday situations, potentially demonstrating the user experience and the underlying processes involved in identifying and mitigating unwanted calls. The sequential nature of the panels may illustrate the step-by-step process of encountering, identifying, and reporting a spam call, as well as the potential broader impacts of such reporting on the telecommunications ecosystem.

The top-left panel depicts a person 1000 sitting at a desk, looking frustrated at their ringing smartphone 1001. The smartphone screen displays an unknown number calling. Above the person's head, a thought bubble containing a question mark is shown, indicating confusion about whether to answer the call. This scene may illustrate the common dilemma faced by users when receiving calls from unfamiliar numbers. The frustration expressed by the person 1000 may suggest the frequency and inconvenience of such calls, potentially highlighting the desire for more effective call screening mechanisms. The question mark in the thought bubble may represent the uncertainty and potential anxiety associated with unknown callers, which may stem from concerns about privacy, security, or simply the desire to avoid unwanted interruptions. This initial scenario may set the stage for demonstrating how spam reporting features may address these user concerns and improve the overall calling experience. The desk setting may suggest that unwanted calls may disrupt work or other important activities, potentially impacting productivity and concentration. The prominent display of the unknown number on the smartphone screen 1001 may emphasize the limitations of basic caller ID systems in protecting users from potential spam calls, underscoring the potential benefits of more advanced spam detection and reporting features.

The top-right panel shows the same person 1000 now holding the smartphone 1001 to their ear. Sound waves 1002 are shown coming from the phone, indicating an automated message or a telemarketer speaking. In the background, a simplified view of the phone's screen with a prominent "Report as Spam" button 1003 is displayed. This panel may illustrate the moment when a user realizes they have answered a spam call. The sound waves 1002 emanating from the phone may represent various types of spam calls, such as robocalls, telemarketing pitches, or scam attempts. The presence of the "Report as Spam" button 1003 on the screen may show how spam reporting features may be integrated directly into the call interface, potentially allowing users to quickly and easily flag unwanted calls as they occur. This seamless integration may encourage more frequent reporting of spam calls, which may in turn contribute to improving the overall effectiveness of the spam detection system. The juxtaposition of the user's annoyed expression and the easily accessible reporting feature may suggest how such tools may empower users to take action against unwanted calls, potentially reducing feelings of helplessness or frustration. The simplified view of the phone screen in the background may also indicate that the spam reporting feature may be designed to be unobtrusive during active calls, balancing functionality with user experience considerations.

The bottom-left panel depicts the person 1000 tapping the "Report as Spam" button on their smartphone screen 1001. A simplified version of the native dialer app interface is shown, displaying the spam reporting options. Above the phone, a small cloud labeled "IMS" 1004 is drawn with an arrow pointing from the phone to the cloud, representing the SIP update message being sent. This panel may illustrate the user taking action to report the unwanted call and the initiation of the spam reporting process within the telecommunications network. The act of tapping the "Report as Spam" button may represent the user's active participation in improving the spam detection system, potentially fostering a sense of empowerment and community engagement in combating unwanted calls. The simplified native dialer app interface may show how spam reporting features may be seamlessly integrated into existing smartphone functionalities, potentially reducing barriers to user engagement with these tools. The small cloud labeled "IMS" 1004 and the arrow pointing from the phone to the cloud may visualize the transmission of spam report data from the user's device to the network infrastructure. This representation may help to illustrate the backend processes involved in spam reporting, potentially highlighting the sophisticated technology underlying these user-facing features

The bottom-right panel shows two people 1005 and 1006 in different locations, both looking at their smartphones 1007. On their screens, the same number that was calling in the first panel is shown, but now with a "Potential Spam" label next to it. Above both people, a shared cloud labeled "Spam Database" 1008 is drawn, indicating that the reported number is now flagged for all users. This final panel may illustrate the potential broader impacts of individual spam reports on the wider user community. The depiction of multiple users benefiting from a single spam report may show how collaborative spam reporting efforts may contribute to a more effective and comprehensive spam prevention system. The "Potential Spam" label on the phone screens may indicate how quickly reported spam information may be disseminated to other users, potentially helping them avoid similar unwanted calls. The shared cloud labeled "Spam Database" 1008 may represent the centralized nature of spam data collection and distribution, potentially enabling rapid updates and consistent protection across a wide user base. The different locations of the two people 1005 and 1006 may suggest the global reach of spam prevention efforts, highlighting how individual actions may have far-reaching positive effects within the telecommunications ecosystem. This panel may also imply the potential for machine learning or artificial intelligence systems to analyze aggregated spam reports and improve spam detection algorithms over time, potentially resulting in more accurate and proactive spam identification for all users.

The native dialer application, which may be considered the primary or default calling interface established by the original equipment manufacturer (OEM) on a mobile device, may be implemented and integrated with the device's operating system in various ways. This integration may range from tight coupling with the OS kernel to a more modular approach utilizing standardized APIs. In some examples, the native dialer may be compiled directly into the OS image, potentially allowing for optimized performance and deeper system access. Alternatively, it may be implemented as a system application with elevated privileges, granting it access to low-level telephony functions that may not be available to third-party applications. The OEM may choose to leverage platform-specific frameworks, such as Android's Telecom framework or iOS's CallKit, to create a seamless integration between the dialer and the underlying telephony stack. This integration may enable features such as call blocking, caller ID, and voicemail management to function cohesively within the native dialer interface. In terms of user experience, the native dialer may be pre-installed and set as the default calling application, potentially appearing as an integral part of the device's core functionality rather than a separate, downloadable app. This out-of-the-box readiness may contribute to a more streamlined initial user experience, as users may not need to configure or download additional software to make and receive calls. The native dialer's privileged status within the OS may allow it to intercept and handle incoming call events more efficiently than third-party alternatives, potentially resulting in faster call connection times and more reliable performance. Additionally, this privileged position may enable the native dialer to access system-level settings and preferences, such as do-not-disturb modes or priority contact lists, providing a more integrated and contextually aware calling experience. OEMs may also choose to implement custom hardware integration, such as dedicated call buttons or sensors, that interface directly with the native dialer, further differentiating it from downloadable alternatives. The native dialer's deep integration may extend to system-wide features like the contacts database, recent calls log, and even voice assistant functionality, potentially creating a more cohesive and intuitive user interface for all call-related activities. Moreover, OEMs may implement power management optimizations specifically for the native dialer, potentially allowing it to operate more efficiently and consume less battery power compared to third-party alternatives. This level of optimization and integration may position the native dialer as a cornerstone of the device's communication capabilities, potentially influencing user preference and reliance on this pre-installed solution for their calling needs.

The native dialer application may offer several potential advantages over non-native alternatives, which may contribute to an enhanced user experience and improved system performance. In some cases, the native dialer may benefit from privileged access to system resources, potentially resulting in faster call initiation and more responsive user interface interactions. Additionally or alternatively, the native dialer may integrate more seamlessly with the device's contacts database, potentially allowing for quicker and more accurate caller identification. In certain implementations, the native dialer may have priority in handling incoming call events, which may lead to more reliable call reception and fewer missed connections. Moreover, in some scenarios, the native dialer may consume less battery power due to optimized code and deeper system integration, potentially extending the device's overall battery life. Furthermore, the native dialer may offer enhanced security features in some cases, leveraging system-level protections to safeguard sensitive call data and user information more effectively than third-party applications. In certain embodiments, the native dialer may provide more consistent performance across different device models and OS versions, potentially reducing compatibility issues and ensuring a uniform user experience. Additionally, in some implementations, the native dialer may offer superior accessibility features, integrating more closely with system-wide accessibility settings to accommodate users with diverse needs. In certain cases, the native dialer may support more advanced call management features, such as Wi-Fi calling or seamless handover between cellular and Wi-Fi networks, which may not be fully available to non-native applications. Moreover, in some scenarios, the native dialer may offer better interoperability with other system applications, potentially enabling more sophisticated workflows and automation possibilities. Furthermore, in certain implementations, the native dialer may provide more accurate and up-to-date caller ID information by leveraging system-level data sources and network operator information. Additionally, in some cases, the native dialer may offer enhanced privacy controls, allowing users to manage their call preferences and blocking settings more granularly than might be possible with third-party alternatives.

In some implementations, the native dialer application may offer a range of features and functionalities that extend beyond the basic spam reporting button, potentially enhancing the user's ability to manage and respond to unwanted calls. For instance, the interface may include multiple buttons or a dropdown menu that allows users to categorize the type of spam call they are reporting, such as "telemarketer," "robocall," "scam," and/or "other." Additionally, the application may provide a text input field where users can add notes or details about the spam call, which may help improve the accuracy of spam detection algorithms. In certain cases, the native dialer may offer a slider or rating system that enables users to indicate their confidence level in identifying a call as spam, potentially allowing the system to weigh reports more accurately. Moreover, the application may include a feature that allows users to block the reported number directly from the spam reporting interface, streamlining the process of preventing future calls from that source. In some scenarios, the native dialer may provide a visual history of reported spam calls, allowing users to review and manage their past reports. Furthermore, the application may offer an option to automatically report calls that exhibit certain characteristics, such as those from known spam prefixes or those that match specific patterns. In certain implementations, the native dialer may include a community-driven feature that shows how many other users have reported a particular number as spam, potentially helping individuals make more informed decisions about answering calls. Additionally, the application may offer customizable spam filtering settings, allowing users to set their preferred level of call screening based on various factors such as time of day, caller location, or call frequency. In some cases, the native dialer may provide real-time transcription of suspected spam calls, enabling users to quickly assess the nature of the call without having to answer it. Moreover, the application may include an educational component that offers tips and best practices for avoiding spam calls and protecting personal information. In certain scenarios, the native dialer may offer integration with third-party spam databases or regulatory do-not-call lists, potentially expanding its spam detection capabilities. Furthermore, the application may provide options for users to report spam calls to relevant authorities or consumer protection agencies directly from the interface. In some implementations, the native dialer may offer a feature that allows users to schedule automatic spam report submissions during off-peak hours, potentially optimizing network usage and improving system responsiveness.

The implementation of spam reporting functionality within the Session Initiation Protocol (SIP) framework may involve various modifications and/or enhancements to certain components and message structures. In some examples, the User Equipment (UE) may generate a SIP UPDATE message to carry spam report information, potentially leveraging this message type in a novel and inventive manner. This technique may allow for seamless integration with current SIP infrastructure while adding new functionality. The SIP UPDATE message may be configured to include additional headers or parameters specifically designed to convey spam-related data, such as the type of spam call, user confidence level, and timestamp information. In certain implementations, these new elements may be formatted as key-value pairs, potentially utilizing URL encoding to ensure safe transmission of special characters. The spam report data may be encrypted using existing SIP security mechanisms, such as Transport Layer Security (TLS), which may help protect user privacy and maintain data integrity during transmission. Additionally, the carrier's IP Multimedia Subsystem (IMS) may be adapted to recognize and process these modified SIP UPDATE messages, potentially involving one or more updates to various components such as the Proxy-Call Session Control Function (P-CSCF), Serving-Call Session Control Function (S-CSCF), and Interrogating-Call Session Control Function (I-CSCF). In some scenarios, a new component or an extension to an existing component may be introduced to interface between the IMS and spam processing systems, such as STIR/SHAKEN. This component may be responsible for extracting spam report data from the SIP messages and forwarding it to the appropriate databases or analysis systems. The native dialer application on the UE may be enhanced to include user interface elements for initiating spam reports, potentially allowing users to categorize the type of spam call or provide additional context. In certain cases, the SIP UPDATE message containing the spam report may be generated and sent even after a call has ended, which may represent a departure from related SIP UPDATE usage. This technique may provide flexibility in when users may report spam calls, potentially improving the user experience and increasing the likelihood of accurate reporting. The parsing and handling logic in network elements may be updated to correctly recognize and process these spam reports, potentially enabling more efficient routing and processing of the information throughout the network. In some implementations, this spam reporting mechanism may be designed to be backwards-compatible with existing SIP infrastructure, allowing for gradual adoption and implementation across different network environments without requiring wholesale changes to core protocols or systems.

More specifically, in some examples, the SIP UPDATE message structure and payload for spam reporting may be enhanced to provide a more comprehensive and flexible mechanism for transmitting spam-related information within the existing SIP framework. The SIP UPDATE message, which in related systems can be used for modifying session parameters without altering the dialog state, may be repurposed to carry detailed spam report data from the User Equipment (UE) to the IP Multimedia Subsystem (IMS). This technique may involve the addition of new headers or the extension of existing headers within the SIP UPDATE message. For instance, a custom "X-Spam-Report" header may be introduced, which may contain key-value pairs representing various aspects of the spam report. These pairs may include, but may not be limited to, the reported phone number, a spam confidence score, a timestamp of the report, and a categorization of the spam type. The payload of the SIP UPDATE message may also be utilized to transmit more extensive information, such as a JSON or XML-formatted object containing additional metadata about the reported call. This metadata may encompass details such as call duration, any audio fingerprints captured during the call, or pattern-matching results from local spam detection algorithms. To ensure compatibility with existing SIP infrastructure, these custom elements may be designed to be ignored by SIP nodes that do not support spam reporting functionality. Additionally, the SIP UPDATE message for spam reporting may incorporate authentication and integrity protection mechanisms, leveraging existing SIP security protocols such as Transport Layer Security (TLS) or Secure MIME (S/MIME). This may help prevent tampering or spoofing of spam reports as they traverse the network. The structure of the SIP UPDATE message may also be designed to support future extensions, allowing for the inclusion of new spam reporting features without breaking backwards compatibility. By utilizing the SIP UPDATE message in this manner, the spam reporting system may seamlessly integrate with existing telecommunications infrastructure while providing a robust and extensible method for conveying detailed spam report information.

In some examples, the implementation of the spam detection algorithm on the User Equipment (UE) side may involve a multi-layered technique that leverages various data points and analysis methods to identify potential spam calls. This algorithm may be integrated directly into the native dialer application, allowing for real-time spam detection without relying solely on network-based solutions. The UE-side spam detection may begin with an initial screening of incoming calls based on a locally stored database of known spam numbers, which may be regularly updated through synchronization with network resources. Beyond simple number matching, the algorithm may employ more sophisticated pattern recognition techniques to identify suspicious calling behaviors. For instance, it may analyze the frequency of calls from a particular number, the duration of previous interactions, and/or the time of day when calls typically occur. The algorithm may also incorporate machine learning models that may be trained on historical call data to recognize evolving spam patterns. These models may be periodically updated with new training data, potentially improving their accuracy over time without requiring full system updates. Additionally, the spam detection algorithm may consider contextual information available on the device, such as the user's contact list, call history, and/or user-defined preferences for call handling. The algorithm may also be designed to operate efficiently within the constraints of mobile device resources, potentially utilizing background processing techniques to minimize impact on battery life and overall system performance. In some scenarios, the UE-side algorithm may work in conjunction with network-based spam detection systems, potentially sharing local insights and receiving real-time updates to enhance overall accuracy. The spam detection process may also include a user feedback mechanism, allowing individuals to correct false positives and/or negatives, which may in turn be used to refine the algorithm's performance. Furthermore, the algorithm may be designed with privacy considerations in mind, potentially implementing data anonymization techniques and/or local processing to minimize the transmission of sensitive call information. This comprehensive, device-side technique for spam detection may provide users with a more immediate and personalized defense against unwanted calls, potentially complementing and enhancing network-based spam prevention measures. The UE-side spam detection algorithm may also incorporate adaptive thresholding techniques, where the sensitivity of spam detection may be dynamically adjusted based on factors such as the user's location, time of day, or recent call patterns. This adaptive technique may help balance the trade-off between catching more spam calls and minimizing false positives. In some implementations, the algorithm may utilize device sensors and contextual data to enhance spam detection accuracy. For example, it may consider the device's current location and compare it with the purported origin of the incoming call, potentially flagging discrepancies as indicators of possible spam. The algorithm may also analyze the audio characteristics of the call in real-time, potentially identifying hallmarks of automated systems or call centers commonly associated with spam calls. To further improve accuracy, the UE-side spam detection may implement a reputation scoring system for phone numbers, which may be updated based on a combination of local user feedback, community reports, and network-provided information. This reputation score may be used as a factor in the overall spam likelihood calculation for incoming calls.

In some examples, the implementation of spam reporting functionality within the native dialer application may vary depending on the specific mobile operating system and device manufacturer. For Android-based devices, such as those produced by Samsung, the native dialer application may be developed using Java and/or Kotlin programming languages, with the core functionality potentially implemented as part of the Android Open Source Project (AOSP) telephony framework. The specific code for the spam reporting algorithm may be integrated into the call handling logic, which may be located in the com.android.phone package within the system partition of the device's file system. This integration may involve modifying the CallScreeningService class to include additional logic for spam detection and reporting. In some scenarios, manufacturers may extend this base implementation with their own proprietary algorithms, which may be stored in device-specific system applications or services. For iOS devices, the native dialer may be implemented using Swift and/or Objective-C, with the core telephony functionality potentially leveraging the CallKit framework. The spam reporting algorithm may be integrated into the CXCallDirectoryProvider class, which may be responsible for handling incoming calls and caller identification. This code may be stored within the Phone.app bundle in the device's system partition. In both Android and iOS implementations, the specific logic for generating SIP UPDATE messages with spam report information may be added to the call termination routines. This may involve modifying the onCallDisconnected method in Android or the provider(_:performEndCallAction:) method in iOS to include the spam reporting functionality. Additionally, the algorithm may interface with platform-specific APIs for accessing call metadata, such as the android.telecom.Call class in Android or CXCall in iOS, to gather relevant information for the spam report. In some cases, certain low-level components of the spam reporting system may be implemented in C or C++ for performance reasons, particularly when interfacing with the device's radio interface layer (RIL). These components may be compiled into native libraries and called from the higher-level Java, Kotlin, or Swift code. Furthermore, device manufacturers may choose to implement certain spam detection algorithms in firmware or even at the chipset level, potentially leveraging machine learning co-processors for more efficient processing. In such scenarios, the native dialer application may interact with these lower-level components through vendor-specific APIs or system calls. The configuration parameters for the spam reporting system, such as thresholds for automated reporting or user preferences, may be stored in the device's system settings database, which on Android devices may be accessed through the Settings.Global class, and on iOS through the UserDefaults system. In some implementations, the spam reporting functionality may be designed as a modular component that can be updated independently of the core operating system, potentially allowing for more frequent refinements and improvements to the spam detection algorithms without requiring full system updates.

In some examples, the integration of STIR/SHAKEN protocols with the spam reporting system may provide a robust framework for enhancing the authenticity and reliability of caller identification in the context of spam prevention. The STIR (Secure Telephone Identity Revisited) and SHAKEN (Signature-based Handling of Asserted information using toKENs) protocols may be incorporated into the existing spam reporting infrastructure, potentially offering an additional layer of verification for reported spam calls. This integration may involve extending the SIP UPDATE message used for spam reporting to include STIR/SHAKEN attestation information. For instance, the SIP UPDATE message may carry a PASSporT (Personal Assertion Token) that contains cryptographically signed information about the calling party's identity. This token may be verified by the receiving network, providing a higher degree of confidence in the authenticity of the spam report. The spam reporting system may also leverage the attestation levels defined by STIR/SHAKEN (A, B, or C) to weight the credibility of incoming spam reports. Reports from calls with higher attestation levels may be given more significance in the spam detection algorithms. Additionally, the integration may allow for the correlation of STIR/SHAKEN verification results with user-reported spam data, potentially identifying patterns of spoofed numbers associated with spam campaigns. The system may also incorporate a feedback loop where confirmed spam reports may be used to update STIR/SHAKEN databases, potentially improving future call authentication processes. In scenarios where STIR/SHAKEN information is not available for a reported spam call, the system may employ alternative verification methods and/or assign a lower confidence score to the report. The integration may extend to the User Equipment (UE) level as well, where the native dialer application may display STIR/SHAKEN verification status alongside spam likelihood indicators, providing users with more comprehensive information to make informed decisions about incoming calls. Furthermore, the combined STIR/SHAKEN and spam reporting data may be used to generate more accurate reputation scores for calling numbers, potentially enhancing the overall effectiveness of spam detection algorithms. The integration may also facilitate more granular policy enforcement, allowing network operators to implement tiered spam prevention measures based on both STIR/SHAKEN attestation levels and spam report data. This synergy between STIR/SHAKEN protocols and the spam reporting system may create a more resilient defense against evolving spam techniques, particularly those involving number spoofing and/or identity manipulation.

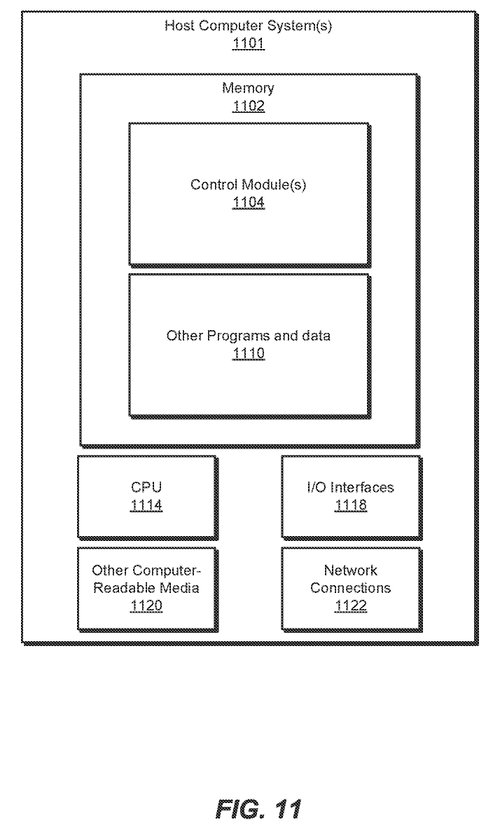

FIG. 11 shows a system diagram that describes an example implementation of a computing system(s) for implementing embodiments described herein. The functionality described herein may be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, enabling higher deployment agility and flexibility. However, FIG. 11 illustrates an example of underlying hardware on which such software and functionality may be hosted and/or implemented.

In particular, shown is example host computer system(s) 1101. For example, such computer system(s) 1101 may execute a scripting application, or other software application, as further discussed above, and/or to perform one or more of the other methods described herein. In some embodiments, one or more special-purpose computing systems may be used to implement the functionality described herein. Accordingly, various embodiments described herein may be implemented in software, hardware, firmware, or in some combination thereof. Host computer system(s) 1101 may include memory 1102, one or more central processing units (CPUs) 1114, I/O interfaces 1118, other computer-readable media 1120, and network connections 1122.

Memory 1102 may include one or more various types of non-volatile and/or volatile storage technologies. Examples of memory 1102 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 1102 may be utilized to store information, including computer-readable instructions that are utilized by CPU 1114 to perform actions, including those of embodiments described herein.

Memory 1102 may have stored thereon control module(s) 1104. The control module(s) 1104 may be configured to implement and/or perform some or all of the functions of the systems or components described herein. Memory 1102 may also store other programs and data 1110, which may include rules, databases, application programming interfaces (APIs), software containers, nodes, pods, clusters, node groups, control planes, software defined data centers (SDDCs), microservices, virtualized environments, software platforms, cloud computing service software, network management software, network orchestrator software, network functions (NF), artificial intelligence (AI) or machine learning (ML) programs or models to perform the functionality described herein, user interfaces, operating systems, other network management functions, other NFs, etc.

Network connections 1122 are configured to communicate with other computing devices to facilitate the functionality described herein. In various embodiments, the network connections 1122 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1118 may include a video interface, other data input or output interfaces, or the like. Other computer-readable media 1120 may include other types of stationary or removable computer-readable media, such as removable flash drives, external hard drives, or the like.

The various embodiments described above may be combined to provide further embodiments. These and other changes may be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving, at a User Equipment (UE), a telephone call from a calling party number;
displaying, in response to the UE detecting that the calling party number is a spam candidate, an option within a native dialer application of the UE that reports the calling party number as spam; and
transmitting, in response to receiving user input selecting the option within the native dialer application of the UE that reports the calling party number as spam, a Session Initiation Protocol (SIP) update message from the native dialer application to an IP Multimedia Subsystem (IMS) that includes information identifying the calling party number as spam such that the IMS updates a spam database with the information identifying the calling party number.

2. The method of claim 1, further comprising:
receiving, at the UE, a subsequent telephone call from the calling party number; and
displaying, based on the updated spam database, an indication that the calling party number is associated with spam.

3. The method of claim 1, wherein detecting that the calling party number is a spam candidate comprises comparing the calling party number to a local spam database stored on the UE.

4. The method of claim 1, wherein the SIP update message comprises a payload that includes the calling party number or a unique identifier associated with the calling party.

5. The method of claim 1, wherein the IMS comprises a Proxy-Call Session Control Function (P-CSCF), a Serving-Call Session Control Function (S-CSCF), or an Interrogating-Call Session Control Function (I-CSCF).

6. The method of claim 1, further comprising:
receiving, at the UE, a SIP INVITE message for an incoming call; and
extracting spam status information from a header of the SIP INVITE message.

7. The method of claim 1, wherein the spam database comprises a local database associated with a service provider or a national database associated with a regulatory agency.

8. The method of claim 1, further comprising:
displaying, within the native dialer application of the UE, a user interface element that enables selection of a reason for reporting the calling party number as spam; and
including the selected reason in the SIP update message transmitted to the IMS.

9. The method of claim 1, further comprising:
receiving, at the UE, a notification from the IMS indicating that the calling party number has been confirmed as spam based on reports from multiple UEs; and
updating a local spam list stored on the UE to include the confirmed spam number.

10. The method of claim 1, wherein the native dialer application comprises a user interface element for reporting spam that is integrated into a call screen or a call log.

11. The method of claim 1, further comprising including authentication information in the SIP update message to enable verification using a Secure Telephone Identity Revisited (STIR) protocol or a Signature-based Handling of Asserted information using toKENs (SHAKEN) framework.

12. The method of claim 1, further comprising receiving, at the UE, a confirmation from the IMS that the spam database has been updated based on the SIP update message.

13. The method of claim 1, further comprising:
receiving, at the UE, a list of known spam numbers from the IMS; and
storing the list in a local cache on the UE.

14. The method of claim 1, wherein the option to report the calling party number as spam is displayed within the native dialer application during the telephone call.

15. The method of claim 1, further comprising:
receiving, at the UE, a user input to unmark a previously reported spam number; and
transmitting a second SIP update message to the IMS that includes information requesting removal of the calling party number from the spam database.

16. The method of claim 1, wherein detecting that the calling party number is a spam candidate comprises analyzing call frequency, call duration, or time of day of previous calls from the calling party number.

17. A non-transitory computer-readable medium that has instructions stored thereon that, when executed by at least one physical computing processor, cause a computing device to perform operations comprising:
receiving, at a User Equipment (UE), a telephone call from a calling party number;
displaying, in response to the UE detecting that the calling party number is a spam candidate, an option within a native dialer application of the UE that reports the calling party number as spam; and
transmitting, in response to receiving user input selecting the option within the native dialer application of the UE that reports the calling party number as spam, a Session Initiation Protocol (SIP) update message from the native dialer application to an IP Multimedia Subsystem (IMS) that includes information identifying the calling party number as spam such that the IMS updates a spam database with the information identifying the calling party number.

18. The non-transitory computer-readable medium of claim 17, wherein detecting that the calling party number is a spam candidate comprises comparing the calling party number to a local spam database stored on the UE.

19. A system comprising:
at least one physical computing processor of a computing device; and
a non-transitory computer-readable medium that has instructions stored thereon that, when executed by the at least one physical computing processor, cause the computing device to perform operations comprising:
receiving, at a User Equipment (UE), a telephone call from a calling party number;
displaying, in response to the UE detecting that the calling party number is a spam candidate, an option within a native dialer application of the UE that reports the calling party number as spam; and
transmitting, in response to receiving user input selecting the option within the native dialer application of the UE that reports the calling party number as spam, a Session Initiation Protocol (SIP) update message from the native dialer application to an IP Multimedia Subsystem (IMS) that includes information identifying the calling party number as spam such that the IMS updates a spam database with the information identifying the calling party number.

20. The system of claim 19, wherein detecting that the calling party number is a spam candidate comprises comparing the calling party number to a local spam database stored on the UE.
